(19) United States
(12) Patent Application Publication
(10) Pub. No.: US 2026/0244125 A1
(43) Pub. Date: Aug. 20, 2026

(54) LIGHT EMITTING DEVICE, OPTICAL WRITING DEVICE USING THE SAME, AND IMAGE FORMING SYSTEM

(71) Applicant: FUJIFILM Business Innovation Corp., Tokyo (JP)

(72) Inventor: Nobutaka HARA, Kanagawa (JP)

(73) Assignee: FUJIFILM Business Innovation Corp., Tokyo (JP)

(21) Appl. No.: 19/296,871

(22) Filed: Aug. 11, 2025

(30) Foreign Application Priority Data
Feb. 18, 2025 (JP) 2025-024376

(51) Int. Cl. G03G 15/041; B41J 2/447; B41J 2/47; B41J 29/393; G03G 15/00; G03G 15/04

(52) U.S. Cl. CPC G03G 15/0415; B41J 2/447; B41J 2/47; B41J 29/393; G03G 15/04036; G03G 15/80

(57) ABSTRACT

A light emitting device includes a light source unit in which plural light emitting elements are arranged on a substrate along a main scanning direction, and a drive unit that drives the plural light emitting elements to cause the plural light emitting elements to emit light at different timings within a predetermined certain period while changing light emission time widths based on the amount of light to be emitted, in which the drive unit includes a correction unit that corrects the light emission time width within a range of a correctable width, which is a range in which the light emission time width is correctable, to make the correctable width vary for each light emitting element.

### CROSS-REFERENCE TO RELATED APPLICATIONS

This application is based on and claims priority under 35 USC 119 from Japanese Patent Application No. 2025-024376 filed Feb. 18, 2025.

### BACKGROUND

### (i) Technical Field

The present invention relates to a light emitting device, and an optical writing device using the same, and an image forming system.

### (ii) Related Art

For example, light emitting devices disclosed in JP2016-030427A (Mode for Carrying Out the Invention and FIGS. 11 and 12), JP2022-053039A (Mode for Carrying Out the Invention and FIG. 11), and JP2010-184448A (Mode for Carrying Out the Invention and FIG. 19) are already known as a light emitting device in the related art.

JP2016-030427A (Mode for Carrying Out the Invention and FIGS. 11 and 12) discloses a light emitting element head including a control unit that turns on a plurality of LEDs using a time equal to or shorter than a first time multiple times in a case where a single lighting time of each of the plurality of LEDs exceeds the first time.

JP2022-053039A (Mode for Carrying Out the Invention and FIG. 11) discloses a light emitting device that corrects density unevenness in a main scanning direction by uniformly correcting the amount of light emitted from light emitting elements included in each group with an increase or a reduction in voltage.

JP2010-184448A (Mode for Carrying Out the Invention and FIG. 19) discloses an exposure device including a time change unit that changes one cycle time of a switching signal for sequentially switching a light emitting element, which is to be driven by a drive element, among a plurality of light emitting elements from a reference time in accordance with an image forming speed, in which the time change unit changes one cycle time from the reference time for some of the light emitting elements during a single main scan, and maintains the one cycle time from the reference time for some of the remaining light emitting elements.

### SUMMARY

Aspects of non-limiting embodiments of the present disclosure relate to a light emitting device, and an optical writing device using the same, and an image forming system that can ensure a light amount-adjustment width required for each light emitting element within a predetermined certain period even in a case where the transfer period of the driving signal given to each light emitting element is shortened, an optical writing device using the light emitting device, and an image forming system.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present invention, there is provided a light emitting device including a light source unit in which a plurality of light emitting elements are arranged on a substrate along a main scanning direction, and a drive unit that drives the plurality of light emitting elements to cause the plurality of light emitting elements to emit light at different timings within a predetermined certain period while changing light emission time widths based on the amount of light to be emitted, in which the drive unit includes a correction unit that corrects the light emission time width within a range of a correctable width, which is a range in which the light emission time width is correctable, to make the correctable width vary for each light emitting element.

### BRIEF DESCRIPTION OF THE DRAWINGS

Exemplary embodiment(s) of the present invention will be described in detail based on the following figures, wherein:

FIG. 1A is a diagram illustrating the overview of an exemplary embodiment of an image forming system in which a light emitting device to which the present invention is applied is built, FIG. 1B is a diagram illustrating the overview of a configuration example of the light emitting device shown in FIG. 1A, FIG. 1C is a diagram illustrating an example of a variation in the amount of emitted light depending on the disposition of each light emitting element of a light source unit, and FIG. 1D is a diagram illustrating a principle of correction of the amount of light for correcting the variation in the amount of emitted light depending on the disposition of each light emitting element shown in FIG. 1C;

FIG. 2 is a diagram illustrating a configuration example of an image forming system according to a first exemplary embodiment;

FIG. 3 is a diagram illustrating an example of an exposure unit as an optical writing device used in the image forming system shown in FIG. 2;

FIG. 4A is a diagram illustrating a configuration example of a light emitting element chip array used in an LED print head shown in FIG. 3, and FIG. 4B is a diagram illustrating an arrangement relationship of the respective light emitting element chips of the light emitting element chip array shown in FIG. 4A;

FIG. 5 is a diagram illustrating various signals that are generated from a signal generation circuit and are input to the light emitting element chip array;

FIG. 6 is a block diagram showing a configuration example of the signal generation circuit;

FIG. 7A is a diagram illustrating a configuration example of a timing signal generation unit of the signal generation circuit shown in FIG. 6, and FIG. 7B is a diagram illustrating an example of transfer period setting data DT2 that is input to the timing signal generation unit;

FIG. 8A is a diagram illustrating a configuration example of the light emitting element chip, FIG. 8B is a diagram illustrating a heat source provided around the light emitting element chip and a power feed direction to the light emitting elements, FIG. 8C is a diagram illustrating an influence of a variation in the amount of light, which is caused by the heat source and the power feed direction, on each light emitting element of the light emitting element chip, and FIG. 8D is a diagram illustrating a principle of correction of a variation in the amount of light emitted the light emitting element chip;

FIG. 9 is a diagram illustrating a circuit configuration example of the light emitting element chip;

FIG. 10A is a diagram illustrating a light amount distribution of the light emitting element chip before density unevenness correction shown in FIG. 6, FIG. 10B is a diagram illustrating a light amount distribution of the light emitting element chip after density unevenness correction shown in FIG. 6, and FIG. 10C is a diagram illustrating a principle of the density unevenness correction;

A part (a) in FIG. 11 is a diagram illustrating a behavior for turning on/off the light emitting element in a case where a transfer period TS of a transfer signal is TSa, and a part (b) in FIG. 11 is a diagram illustrating a behavior for turning on/off the light emitting element in a case where the transfer period TS of the transfer signal is TSb (TSb <TSa);

A part (a) in FIG. 12 is a diagram illustrating a relationship between the amount of light correction required for a variation in the amount of light, which is caused by the heat source and the power feed direction, for each light emitting element of the light emitting element chip and the position of each light emitting element, and a part (b) in FIG. 12 is a diagram showing a method of ensuring each amount of light correction shown in the part (a) in FIG. 12;

FIG. 13A is a diagram illustrating a relationship between a transfer signal for each light emitting element of the present exemplary embodiment and a lighting signal for each light emitting element, and FIG. 13B is a diagram illustrating a relationship between a transfer signal for each light emitting element of a comparative exemplary embodiment and a lighting signal for each light emitting element;

FIG. 14A is a diagram illustrating a configuration example of a light emitting element chip used in an exposure unit according to a second exemplary embodiment, FIG. 14B is a diagram illustrating a heat source provided around the light emitting element chip and a power feed direction to light emitting elements, and FIG. 14C is a diagram illustrating an influence of a variation in the amount of light, which is caused by the heat source and the power feed direction, on each light emitting element of the light emitting element chip;

A part (a) in FIG. 15 is a diagram illustrating a relationship between the amount of light correction required for a variation in the amount of light, which is caused by the heat source and the power feed direction, for each light emitting element of the light emitting element chip and the position of each light emitting element, and a part (b) in FIG. 15 is a diagram showing a method of ensuring each amount of light correction shown in the part (a) in FIG. 15;

FIG. 16A is a diagram illustrating a configuration example of a light emitting element chip used in an exposure unit according to a third exemplary embodiment, FIG. 16B is a diagram illustrating a heat source provided around the light emitting element chip and a power feed direction to light emitting elements, and FIG. 16C is a diagram illustrating an influence of a variation in the amount of light, which is caused by on the heat source and the power feed direction, on each light emitting element of the light emitting element chip;

FIG. 17A is a diagram illustrating a configuration example of a light emitting element chip used in an exposure unit according to a fourth exemplary embodiment, FIG. 17B is a diagram illustrating a heat source provided around the light emitting element chip and a power feed direction to light emitting elements, and FIG. 17C is a diagram illustrating an influence of a variation in the amount of light, which is caused by the heat source and the power feed direction, on each light emitting element of the light emitting element chip;

FIG. 18A is a diagram illustrating a configuration example of a light emitting element chip used in an exposure unit according to a fifth exemplary embodiment, FIG. 18B is a diagram illustrating heat sources provided around the light emitting element chip and a power feed direction to light emitting elements, and FIG. 18C is a diagram illustrating an influence of a variation in the amount of light, which is caused by the heat sources and the power feed direction, on each light emitting element of the light emitting element chip;

FIG. 19A is a diagram illustrating a configuration example of a light emitting element chip array used in an exposure unit according to a sixth exemplary embodiment, FIG. 19B is a diagram illustrating a heat source provided around a light emitting element chip of an even-numbered row and a power feed direction to light emitting elements; and FIG. 19C is a diagram illustrating an influence of a variation in the amount of light, which is caused by the heat source and the power feed direction, on each light emitting element of a light emitting element chip of an odd-numbered row; and

FIG. 20A is a diagram illustrating a relationship between the amount of light correction required for a variation in the amount of light, which is caused by the heat source and the power feed direction, emitted from each of light emitting elements of light emitting element chips of even-numbered rows and the position of each light emitting element, FIG. 20B is a diagram illustrating a correction processing example for a variation in the amount of light, which is caused by the heat source and the power feed direction, emitted from the light emitting element chips of even-numbered rows, FIG. 20C is a diagram illustrating a relationship between the amount of light correction required for a variation in the amount of light, which is caused by the heat source and the power feed direction, emitted from each of light emitting elements of light emitting element chips of odd-numbered rows and the position of each light emitting element, and FIG. 20D is a diagram illustrating a correction processing example for a variation in the amount of light, which is caused by the heat source and the power feed direction, emitted from the light emitting element chips of the odd-numbered rows.

### DETAILED DESCRIPTION

### Overview of Exemplary Embodiment

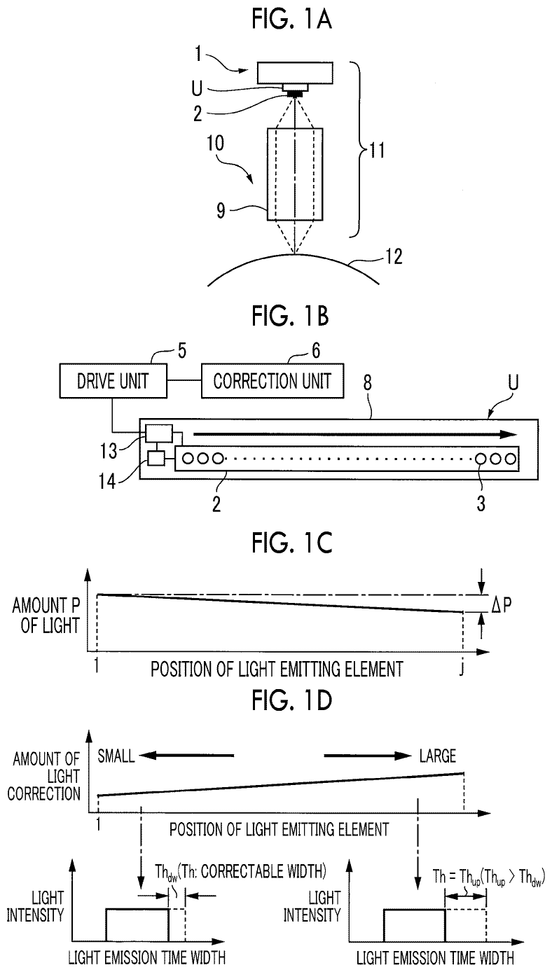

FIG. 1A shows an overview of an exemplary embodiment of an image forming system to which the present invention is applied.

In FIG. 1A, the image forming system 10 includes an optical writing device 11, and an image holding unit 12 that is provided to face the optical writing device 11 and holds an image formed using light.

Here, the optical writing device 11 includes a light emitting device 1 and an imaging unit 9 that forms an image on the image holding unit 12 using light emitted from each light emitting element chip U of the light emitting device 1.

The image holding unit 12 mentioned herein is not limited to a photoreceptor, and also includes a dielectric body and the like. The form of the image holding unit 12 may be appropriately selected from a drum shape, a belt shape, and the like. Further, examples of the image formed using light include an electrostatic latent image that is formed with a potential difference obtained in a case where the image holding unit is charged to a predetermined level and electricity is then eliminated from the image holding unit using light corresponding to an image pattern.

Furthermore, the imaging unit 9 may be appropriately selected as long as the imaging unit 9 forms an image on the image holding unit 12 using light emitted from each light emitting element chip U of the light emitting device 1. Examples of the imaging unit 9 include a lens that refracts light on a surface thereof (for example, a cylindrical lens) and a lens that refracts light inside (for example, a gradient index lens).

In addition, as shown in FIG. 1B, the light emitting device 1 includes a light source unit 2 in which a plurality of light emitting elements 3 are arranged on a substrate 8 along a main scanning direction, and a drive unit 5 that drives the plurality of light emitting elements 3 to cause the plurality of light emitting elements 3 to emit light at different timings within a predetermined certain period while changing light emission time widths based on the amount of light to be emitted. Further, the drive unit 5 includes a correction unit 6 that corrects the light emission time width within a range of a correctable width, which is a range in which the light emission time width is correctable, to make the correctable width vary for each light emitting element 3.

In FIG. 1B, reference numeral 13 denotes a power feed unit that supplies a driving signal from the drive unit 5 to each light emitting element 3 of the light source unit 2, and reference numeral 14 denotes a resistance unit that limits current to be supplied to each light emitting element 3.

In such technical means, examples of the light source unit 2 include an array type unit in which a plurality of light emitting elements 3 are arranged in the main scanning direction. Here, examples of the light emitting element 3 include a light emitting thyristor and a light emitting diode. Further, the plurality of light emitting elements 3 may be arranged in an aspect in which the plurality of light emitting elements 3 are divided and arranged in the plurality of light emitting element chips U, or in an aspect in which the respective light emitting element chips U are arranged in a staggered pattern or divided and arranged in three or more rows. Furthermore, the aspect in which the plurality of light emitting elements 3 are arranged also includes an aspect in which the plurality of light emitting elements 3 are arranged in a staggered pattern or divided and arranged in three or more rows in each light emitting element chip U.

In addition, the drive unit 5 may drive the plurality of light emitting elements 3 at different timings within a predetermined certain period. In this case, a driving method may be a method of driving the plurality of light emitting elements 3 to cause the plurality of light emitting elements 3 to emit light while changing the light emission time widths based on the amount of light to be emitted. Here, the amount of light to be emitted may be fixed in advance or may be selected to be variable.

Further, in the present exemplary embodiment, the drive unit 5 may include the correction unit 6 that corrects the light emission time width within a range of a correctable width which is a range in which the light emission time width is correctable. Here, the correction unit 6 needs to make a correctable width Th vary for each light emitting element 3. For this reason, the correctable width Th is not a predetermined constant value, and an appropriate correctable width Th is selected for each light emitting element 3.

The light emitting device 1 including the above-described components acts as follows.

Generally, in the light source unit 2 including the plurality of light emitting elements 3, the amount of light in the main scanning direction varies due to manufacturing variations or variations in the transmittance of the imaging unit 9. As a result, shading (density unevenness) in image quality is caused. For this reason, in order to ensure image quality, it is necessary to correct the amount of light for density unevenness for each light emitting element 3.

In this case, in the present exemplary embodiment, the drive unit 5 employs a method of causing the plurality of light emitting elements 3 to emit light while changing the light emission time widths based on the amount of light to be emitted. For this reason, in order to correct the amount of light, basically, the light emission time width may be adjusted for each light emitting element 3.

However, in a case where the printing speed of the image forming system 10 is increased, the writing speed of the optical writing device 11 needs to be increased accordingly. In this case, since a light emission time given to each light emitting element 3 is shortened, the correctable width Th in which the light emission time width is correctable may be insufficient in the light emitting device 1.

That is, the correctable width Th described above is determined depending on a transfer period of a driving signal for each light emitting element 3. However, in a case where a uniform reference transfer period is determined as the transfer period of the driving signal as in the related art, the correctable width Th may be insufficient in the light emitting element 3 of which the amount of variation in the amount of light is predicted to be large.

Therefore, the present inventor has examined the variation characteristics of the amount of light emitted from the light source unit 2 for the light emitting device 1 on which light amount correction processing for density unevenness is performed, so that the following results have been obtained.

That is, it has been found that the amount of variation in the amount of light changes depending on the arrangement position of the light emitting element 3 in the light source unit 2 in which the plurality of light emitting elements 3 are arranged.

In the example shown in FIG. 1B, change characteristics in which the amount of light tends to gradually decrease from the first light emitting element 3 toward the last j-th light emitting element 3 among the plurality of light emitting elements 3 have been confirmed (see FIG. 1C).

In FIG. 1C, it is assumed that there are change characteristics in which the amount of light emitted from the last j-th light emitting element 3 tends to decrease by ΔP as compared to the amount of light emitted from the first light emitting element 3. In order to correct such a variation in the amount of light, it is preferable that, for example, the amount of light correction of the j-th light emitting element 3 is allocated to be sufficiently larger than the amount of light correction of the first light emitting element 3 as shown in FIG. 1D.

That is, in the example shown in FIG. 1D, the correctable width Th is increased to Thup in the light emitting element 3 of which the amount of light correction is predicted to be large. On the other hand, the correctable width Th is reduced to Thdw in the light emitting element 3 of which the amount of light correction is predicted to be small.

At this time, in a case where the correctable width Th is to be increased, for example, the transfer period TS of the driving signal may be increased. On the other hand, in a case where the correctable width Th is to be reduced, for example, the transfer period TS of the driving signal may be reduced. In this case, the transfer period of the driving signal for each light emitting element 3 may be adjusted such that the total of the transfer periods of the driving signals for one line is a predetermined period.

Next, a representative aspect or a desired aspect of the light emitting device according to the present exemplary embodiment will be described.

First, examples of a representative aspect of the correction unit 6 include an aspect in which the correction unit 6 corrects the correctable width such that the correctable width Th for the light emitting element 3 of which the amount of variation in the amount of light is predicted to be large among the light emitting elements 3 is larger than the correctable width Th for the light emitting element 3 of which the amount of variation in the amount of light is predicted to be small.

In the present exemplary embodiment, examples of the desired correction unit 6 includes an aspect in which the correction unit 6 corrects the correctable width such that the correctable width Th for the light emitting element 3 of which the amount of variation in the amount of light is predicted to be larger than a predetermined reference amount of variation among the light emitting elements 3 is larger than a predetermined reference value, and corrects the correctable width such that the correctable width Th for the light emitting element 3 of which the amount of variation in the amount of light is predicted to be smaller than the reference amount of variation is smaller than the reference value.

In a case where this type of correction unit 6 corrects the correctable width Th for each light emitting element 3, it is preferable that the correction unit 6 includes a first correctable width group making the correctable width Th larger than the reference value and a second correctable width group making the correctable width Th smaller than the reference value, and corrects the correctable width Th such that, for example, a total value of differences between the first correctable width group and the reference value and a total value of differences between the second correctable width group and the reference value are substantially equal to each other.

Further, in an aspect in which the light emitting device 1 includes the power feed unit 13 that is provided on a side of an end portion of the light source unit 2 in the main scanning direction on the substrate 8 and feeds power to each light emitting element 3 as shown in FIG. 1B, the correction unit 6 may make the correctable width Th vary depending on a distance or a wiring length between the power feed unit 13 and the light emitting element 3. This is in consideration of the fact that a direction of power fed by the power feed unit 13 is a factor causing a variation in the amount of light emitted from each light emitting element 3.

In the present exemplary embodiment, it is preferable that the correction unit 6 corrects the correctable width such that, for example, the correctable width Th is larger as the distance or the wiring length between the power feed unit 13 and the light emitting element 3 is longer.

Furthermore, in an aspect in which the light emitting device 1 includes the resistance unit 14 that is provided on the side of the end portion of the light source unit 2 in the main scanning direction on the substrate 8 and limits current to be supplied to the light emitting elements 3 as shown in FIG. 1B, the correction unit 6 may make the correctable width Th of the light emitting element 3 vary depending on a distance between the resistance unit 14 and the light emitting element 3. This is in consideration of the fact that the resistance unit 14 serves as a heat source and is a factor causing a variation in the amount of light emitted from each light emitting element 3.

In the present exemplary embodiment, it is preferable that the correction unit 6 corrects the correctable width such that, for example, the correctable width Th of the amount of light emitted from the light emitting element 3 is larger as the distance between the resistance unit 14 and the light emitting element 3 is shorter.

In addition, in an aspect in which the light emitting device 1 includes the power feed unit 13 that is provided on the side of the end portion of the light source unit 2 in the main scanning direction on the substrate 8 and feeds power to each light emitting element 3, and the resistance unit 14 that is provided on the side of the end portion of the light source unit 2 in the main scanning direction on the substrate 8 and limits current to be supplied to the light emitting elements 3, and the power feed unit 13 is disposed on a side of the light source unit 2 opposite to the resistance unit 14, the correction unit 6 may make the correctable width Th vary depending on a distance or a wiring length between the power feed unit 13 and the light emitting element 3 and a distance between the resistance unit 14 and the light emitting element 3.

In the present exemplary embodiment, the variation characteristics of the amount of light depending on the distance or the wiring length between the power feed unit 13 and the light emitting element 3 and the variation characteristics of the amount of light depending on the distance between the resistance unit 14 and the light emitting element 3 cancel each other out. For this reason, the present exemplary embodiment is superior to the aspect shown in FIG. 1B (an aspect in which the power feed unit 13 and the resistance unit 14 are disposed on the side of an identical end portion of the light source unit 2 in the main scanning direction) in that the maximum amount of variation in the amount of light can be suppressed to be small.

Further, in an aspect in which the plurality of light emitting elements 3 of the light source unit 2 are divided and arranged in a plurality of sets, the correction unit 6 may make the correctable width Th vary in parallel for each of the light emitting elements 3 that are divided into the sets.

In the present exemplary embodiment, in the aspect in which the light source unit 2 consists of a plurality of systems that use a common driving signal for each identical set, it is preferable that the correction unit 6 performs, for example, processing of correcting the correctable width Th for the light emitting element 3 belonging to any one set of systems and processing of correcting the correctable width Th for the light emitting element 3 belonging to another set of systems in parallel.

The present invention will be described in more detail based on exemplary embodiments shown in the accompanying drawings.

### First Exemplary Embodiment

### Overall Configuration of Image Forming System

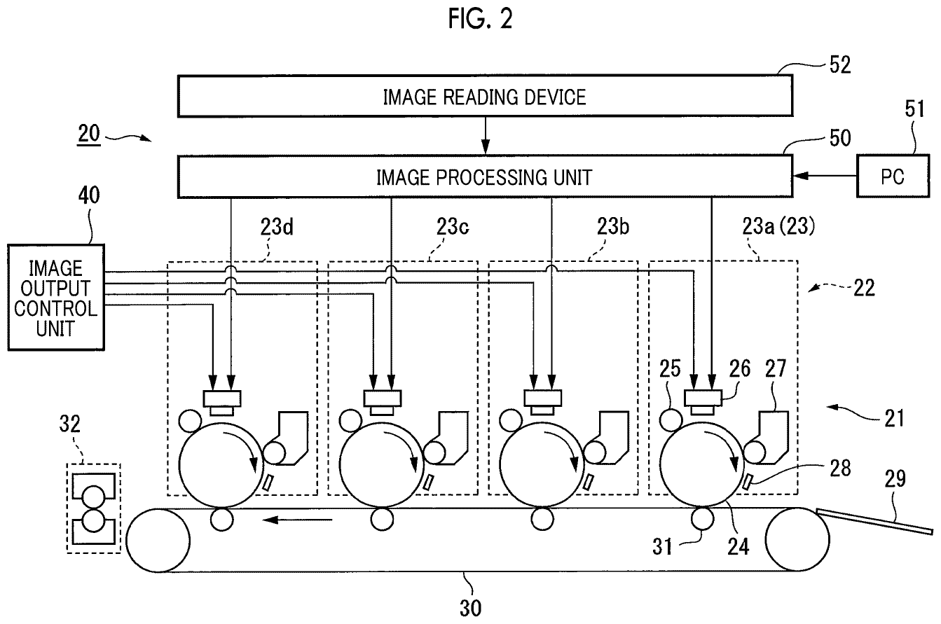

FIG. 2 shows the overall configuration of an image forming system according to a first exemplary embodiment.

In FIG. 2, the image forming system 20 is an image forming system generally called a tandem type. The image forming system 20 includes an image forming process section 21, an image output control unit 40, and an image processing unit 50. Here, the image forming process section 21 is a functional unit that performs image forming to correspond to image data for each color. Further, the image output control unit 40 is a functional unit that controls the image forming process section 21. Furthermore, the image processing unit 50 is connected to, for example, a personal computer (PC) 51 and an image reading device 52, and performs predetermined image processing on image data received from the personal computer 51 and the image reading device 52.

The image forming process section 21 includes image forming units 22 that are arranged in parallel at regular intervals. The image forming unit 22 is formed of four image forming engines 23 (23a to 23d) which are an example of toner image forming units. The toner image forming units mentioned herein are functional units that form toner images for four colors (yellow (Y), magenta (M), cyan (C), and black (K) in the present exemplary embodiment). Further, each of the image forming engines 23 (23a to 23d) includes an image holding unit that forms an electrostatic latent image and holds a toner image. In the present exemplary embodiment, for example, a drum-shaped photoreceptor 24 is used as an example of the image holding unit. A charger 25, an exposure unit 26 as an optical writing device, and a developing unit 27 are provided around the photoreceptor 24. Here, the charger 25 uniformly charges the surface of the photoreceptor 24 to a predetermined potential. The exposure unit 26 is to expose the photoreceptor 24, which is charged by the charger 25, to form an electrostatic latent image. The developing unit 27 develops the electrostatic latent image formed by the exposure unit 26.

Then, the image forming engines 23 (23a to 23d) form a yellow (Y) toner image, a magenta (M) toner image, a cyan (C) toner image, and a black (K) toner image, respectively.

Further, the image forming process section 21 multiple-transfers and fixes the respective color toner images, which are formed on the photoreceptors 24 of the respective image forming engines 23 (23a to 23d), onto a recording sheet 29 as an example of a recording medium. In the present exemplary embodiment, the image forming process section 21 includes a sheet transport belt 30, transfer units 31, and a fixing unit 32. Here, the sheet transport belt 30 is to transport the recording sheet 29. The transfer unit 31 is to transfer the toner image, which is formed on the photoreceptor 24, onto the recording sheet 29, and a transfer roller is used as the transfer unit 31 in the present exemplary embodiment. The fixing unit 32 is to fix the toner image transferred onto the recording sheet 29.

In the image forming system 20, the image forming process section 21 performs an image forming operation based on various control signals supplied from the image output control unit 40. Then, in a case where image data is received from the personal computer (PC) 51 or the image reading device 52, the image data is processed as follows. That is, the image data is supplied to the image forming engines 23 after being subjected to image processing by the image processing unit 50 under the control of the image output control unit 40.

For example, in the image forming engine 23d for black (K), the photoreceptor 24 is charged to a predetermined potential by the charger 25 while being rotated in a direction of an arrow. After that, the photoreceptor 24 is exposed by the exposure unit 26 that emits light based on the image data supplied from the image processing unit 50. Accordingly, an electrostatic latent image related to a black (K) image is formed on the photoreceptor 24. Then, the electrostatic latent image formed on the photoreceptor 24 is developed by the developing unit 27, so that a black (K) toner image is formed on the photoreceptor 24. Similarly, a yellow (Y) toner image, a magenta (M) toner image, and a cyan (C) toner image are also formed in the image forming engines 23 (23a to 23c), respectively.

The respective color toner images formed on the photoreceptors 24 by the respective image forming engines 23 (23a to 23d) are multiple-transferred onto the recording sheet 29. In the present exemplary embodiment, the recording sheet 29 is supplied as the sheet transport belt 30 is moved in a direction of an arrow. Then, the respective color toner images are sequentially electrostatically transferred onto the recording sheet 29 by a transfer electric field applied to the transfer units (transfer rollers) 31. For this reason, a composite toner image in which the respective color toners are superimposed on the recording sheet 29 is formed.

After that, the recording sheet 29 onto which the composite toner image is electrostatically transferred is transported to the fixing unit 32. Then, the composite toner image transferred onto the recording sheet 29 is subjected to fixing processing using heat and pressure by the fixing unit 32 and is fixed onto the recording sheet 29, and the recording sheet 29 is discharged from the image forming system 20.

In addition, residues (residual toner, paper dust, and the like) on the photoreceptors 24 and the sheet transport belt 30 are appropriately cleaned by cleaning units (not shown).

### Configuration Example of Exposure Unit

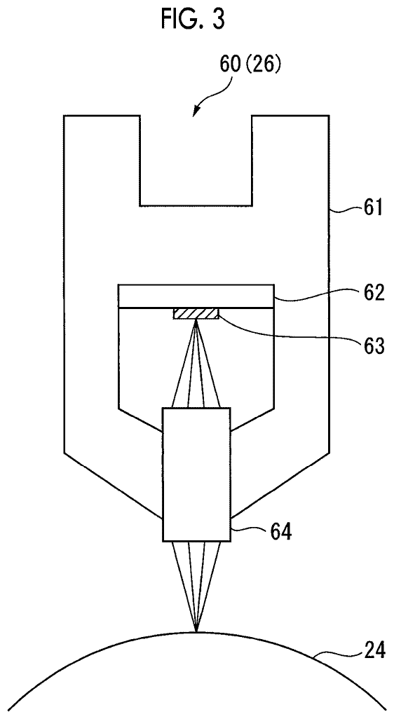

FIG. 3 shows a configuration example of the exposure unit 26 used in the present exemplary embodiment.

In FIG. 3, the exposure unit 26 is formed of an LED print head (hereinafter, abbreviated as “LPH”) 60 that uses an LED as a light emitting element.

The LPH 60 includes a holder 61 that serves as a holding member, a light emitting element chip array 63 that forms a light emitting unit, and an imaging lens 64 that is an example of an imaging unit.

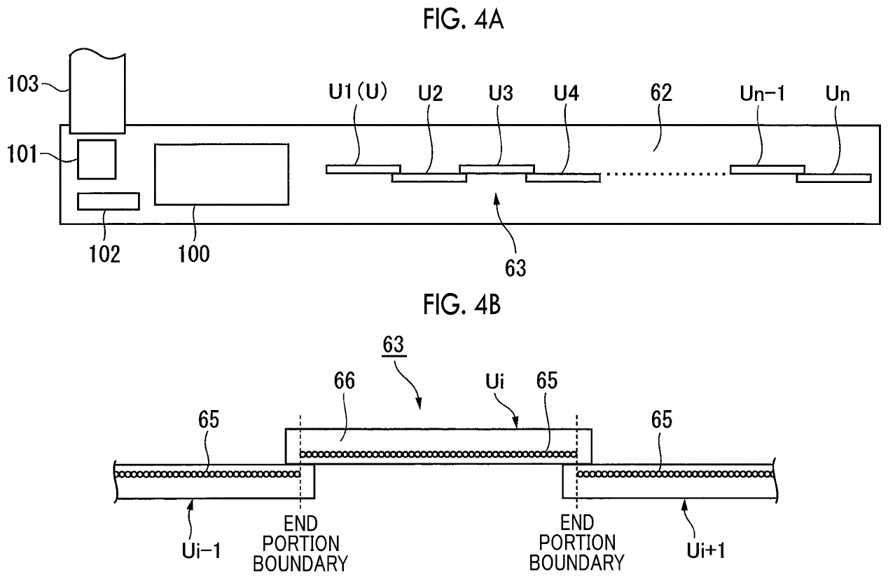

In the present exemplary embodiment, the light emitting element chip array 63 is formed of, for example, a self-scanning light emitting device (LED) array. Further, the light emitting element chip array 63 is driven by a driving signal that is generated from a drive circuit (signal generation circuit) 100 as a driving signal generation unit. In the present exemplary embodiment, the light emitting element chip array 63, the signal generation circuit 100 (see FIG. 4A), and the like are mounted on a circuit board 62. In addition, the imaging lens 64 is an optical member that forms an image on the surface of the photoreceptor 24 using light emitted from the light emitting element chip array 63, and is formed of, for example, a rod lens array.

In the present exemplary embodiment, the holder 61 is formed of a block or sheet metal, such as aluminum or SUS, and holds the circuit board 62 and the imaging lens 64. Further, the holder 61 is adapted to match light emitting points of LEDs (see FIG. 4B), which serve as light emitting elements 65 of the light emitting element chip array 63, with a focal plane of the imaging lens 64. Furthermore, the respective rod lenses as the imaging lens 64 are arranged along an axial direction of the photoreceptor 24 (corresponding to the main scanning direction).

The LPH 60 having such a configuration is adapted to be movable in a direction of an optical axis of the imaging lens 64 by an adjustment screw (not shown), and is adjusted such that an imaging position (focal plane) of the imaging lens 64 is positioned on the surface of the photoreceptor 24.

### Configuration Example of Circuit Board

FIG. 4A is a plan view of the circuit board 62.

In FIG. 4A, the light emitting element chip array 63 is an array in which a plurality of light emitting element chips U (specifically, U1 to Un) are arranged on the circuit board 62. In the present exemplary embodiment, the respective light emitting element chips U are arranged in two rows in the axial direction of the photoreceptor 24 (corresponding to the main scanning direction) in a staggered pattern. Further, each of the light emitting element chips U (U1 to Un) includes a chip substrate 66, and the light emitting elements 65 are arranged on each chip substrate 66 in the main scanning direction.

The reason why the light emitting element chips U (U1 to Un) are arranged in a staggered pattern in the present exemplary embodiment is as follows. In a case where the plurality of light emitting element chips U are arranged in one direction, an interval between the light emitting elements 65 may not be capable of being made constant at an end portion of each light emitting element chip U. In order to avoid this, as shown in FIG. 4B, the respective light emitting element chips U may be arranged in a staggered pattern and end portions of the respective light emitting element chips U may be arranged to partially overlap with each other. In this case, a structure in which an interval between the light emitting elements 65 at the end portion of each of the light emitting element chips U (Ui−1, Ui, and Ui+1) is kept constant can be obtained.

Further, as shown in FIG. 4A, the circuit board 62 is provided with a signal generation circuit 100, a power supply voltage control unit 101 that outputs a power supply voltage Vsub, an EEPROM 102 that stores light amount correction value data and the like for the light emitting element chip array 63, and a harness 103 that transmits and receives signals between the image output control unit 40 and the image processing unit 50 of the image forming system 20.

### Various Driving Signals Input to Light Emitting Element Chip Array

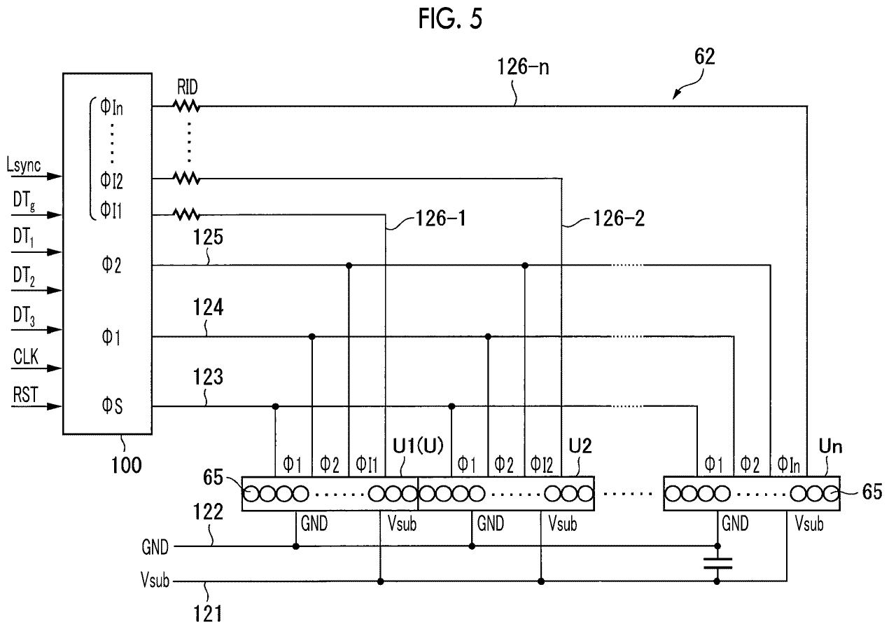

FIG. 5 shows various driving signals that are generated from the signal generation circuit 100 and input to the light emitting element chip array 63.

In FIG. 5, various control signals are input to the signal generation circuit 100 from the image output control unit 40, the image processing unit 50, and the like. Here, the control signals include a horizontal synchronization signal Lsync, image data DTg, other data DT1 to DT3, a clock signal CLK, and a reset signal RST. Then, the signal generation circuit 100 outputs lighting signals ΦI (ΦI1 to ΦIn) to the respective light emitting elements 65 of the respective light emitting element chips U (U1 to Un) by performing, for example, the rearrangement of the image data DTg or the correction of an output value based on various control signals input from the outside.

Further, the signal generation circuit 100 outputs a start transfer signal (corresponding to the horizontal synchronization signal Lsync) ΦS, a first transfer signal Φ1, and a second transfer signal Φ2 to each of the light emitting element chips U (U1 to Un) based on various control signals input from the outside.

The circuit board 62 is provided with a power line 121 for a power supply voltage Vsub that is connected to power supply terminals of the respective light emitting element chips U (U1 to Un) and a power line 122 for grounding that is connected to GND terminals. Furthermore, the circuit board 62 is also provided with a start transfer signal line 123, a first transfer signal line 124, and a second transfer signal line 125 that transmit the start transfer signal ΦS, the first transfer signal Φ1, and the second transfer signal Φ2 of the signal generation circuit 100. In addition, the circuit board 62 is also provided with n lighting signal lines 126 (126-1 to 126-n) that output the lighting signals ΦI (ΦI1 to ΦIn) from the signal generation circuit 100 to each of the light emitting element chips U (U1 to Un). The circuit board 62 is provided with current limiting resistors RID for preventing excessive current from flowing to the n lighting signal lines 126.

### Configuration Example of Signal Generation Circuit

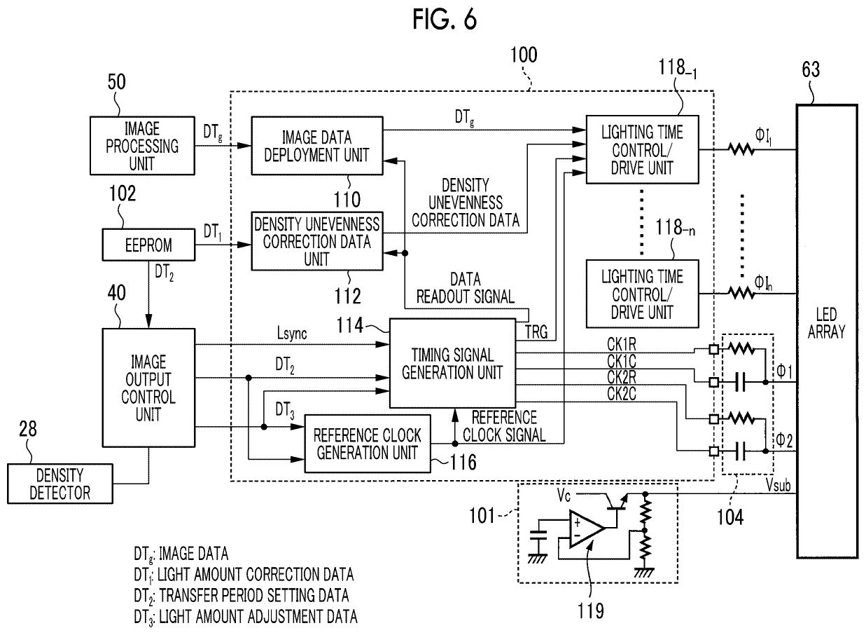

FIG. 6 is a block diagram showing the configuration of the signal generation circuit 100.

Major components of the signal generation circuit 100 are formed of an image data deployment unit 110, a density unevenness correction data unit 112, a timing signal generation unit 114, a reference clock generation unit 116, and lighting time control/drive units 118 (specifically, 118-1 to 118-n) provided to correspond to the respective light emitting element chips U (U1 to Un).

### Image Data Deployment Unit

Image data is serially transmitted from the image processing unit (IPS) 50 to the image data deployment unit 110. The image data deployment unit 110 divides the transmitted image data into image data for the 1st to j-th (j: for example, 128) dots, the (j+1)th to (2×j)th dots, . . . , the [(n−1)×j+1]th to (n×j)th dots, and image data for each of the light emitting element chips U (U1 to Un). The image data deployment unit 110 is connected to the lighting time control/drive units 118, and outputs the divided image data to the corresponding lighting time control/drive units 118-1 to 118-n, respectively.

### Density Unevenness Correction Data Unit

The density unevenness correction data unit 112 stores density unevenness correction data that is used to correct image density unevenness during image formation caused by a variation in the amount of light emitted from each LED of each light emitting element chip U. Then, the density unevenness correction data is output to the lighting time control/drive units 118 in synchronization with a data readout signal from the density unevenness correction data unit 112. The density unevenness correction data is data set for each LED according to a variation in the amount of light emitted from each LED, and the like, and is formed of, for example, 8-bit data in the present exemplary embodiment.

Light amount correction data DT1 for each LED is stored in the EEPROM 102. Then, in a case where a machine is powered, the light amount correction data DT1 for each LED is downloaded from the EEPROM 102 to the density unevenness correction data unit 112. Accordingly, the light amount correction data DT1 is stored in the density unevenness correction data unit 112 as the density unevenness correction data. The light amount correction data DT1 is treated as the density unevenness correction data in the present exemplary embodiment, but the density unevenness correction data may be generated based on the light amount correction data DT1 and other data.

Here, the light amount correction data DT1 for each LED stored in the EEPROM 102 is obtained as follows. The amount of light emitted from each LED is measured by a light profile measurement device or the like, and the light amount correction data DT1 for each LED is generated based on data of the measured amount of light.

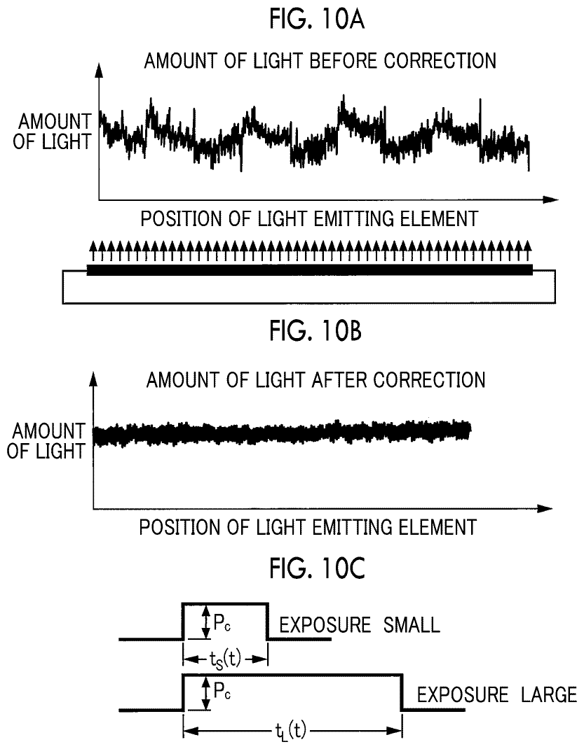

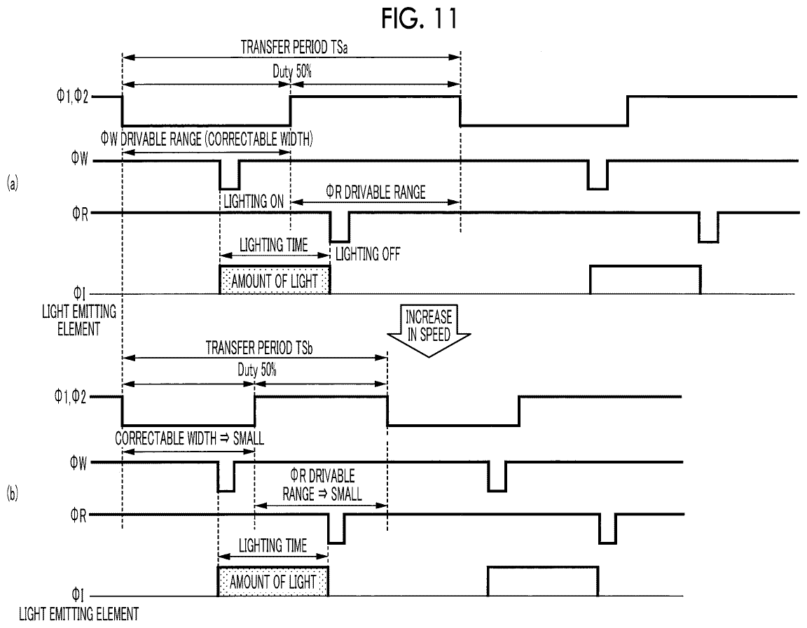

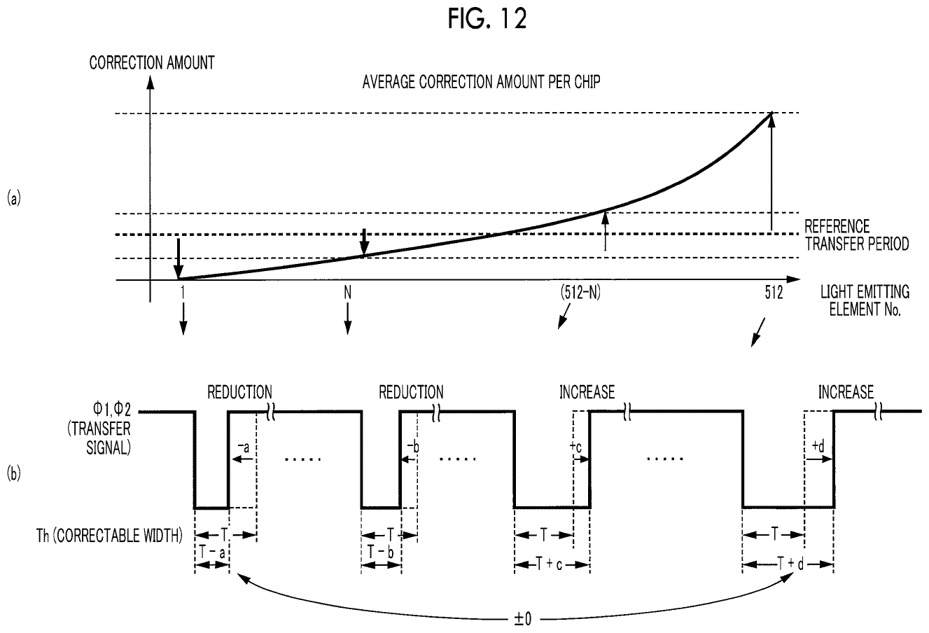

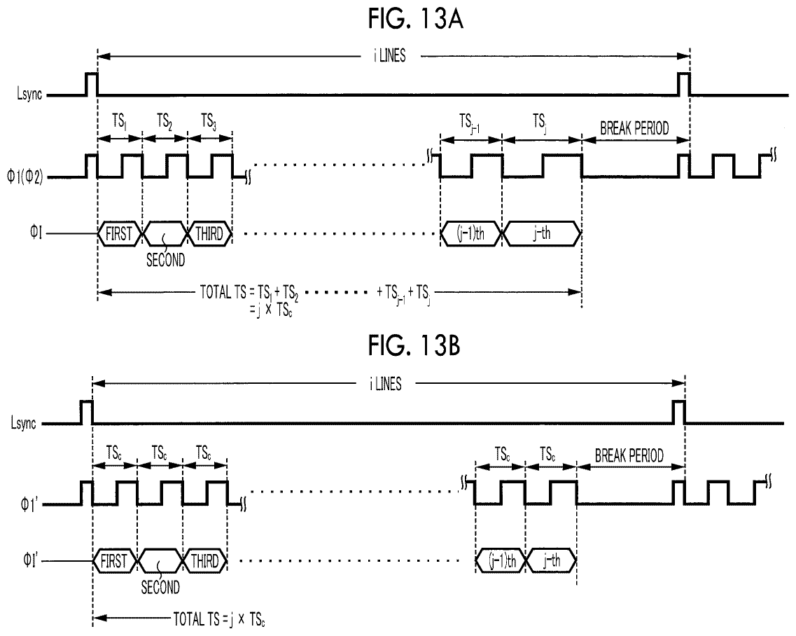

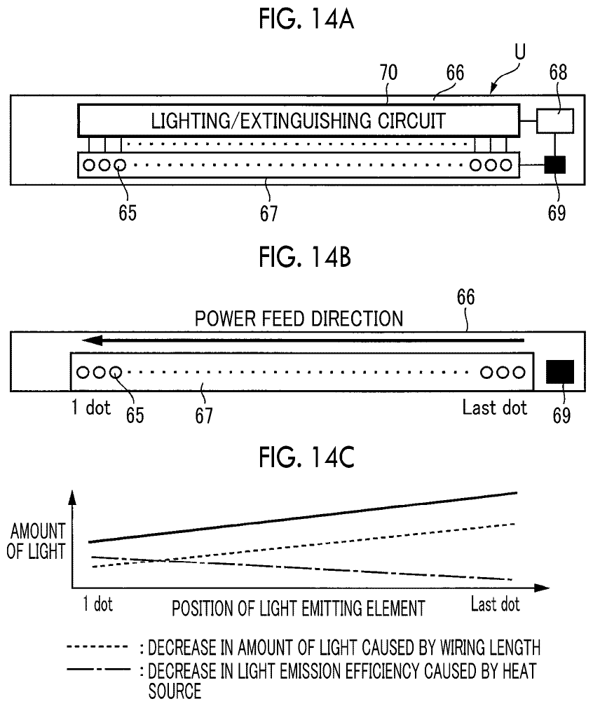

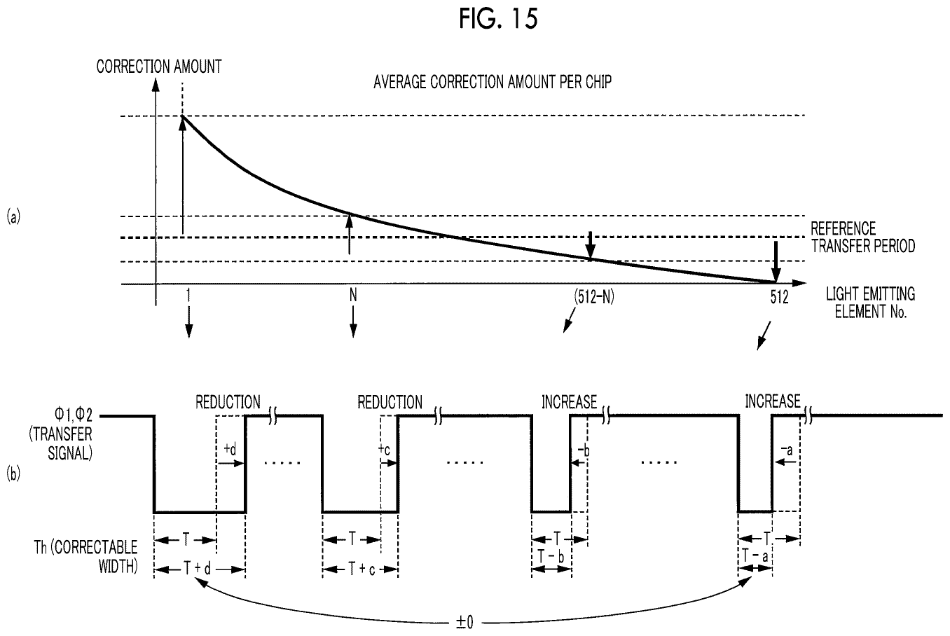

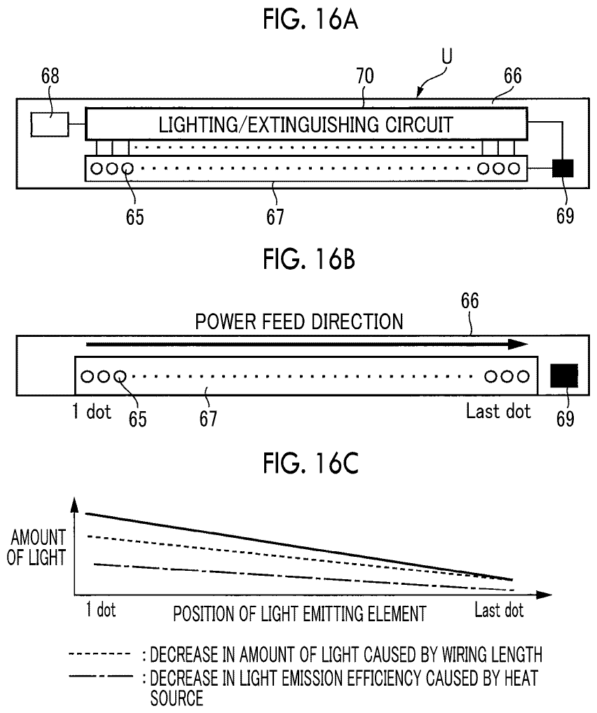

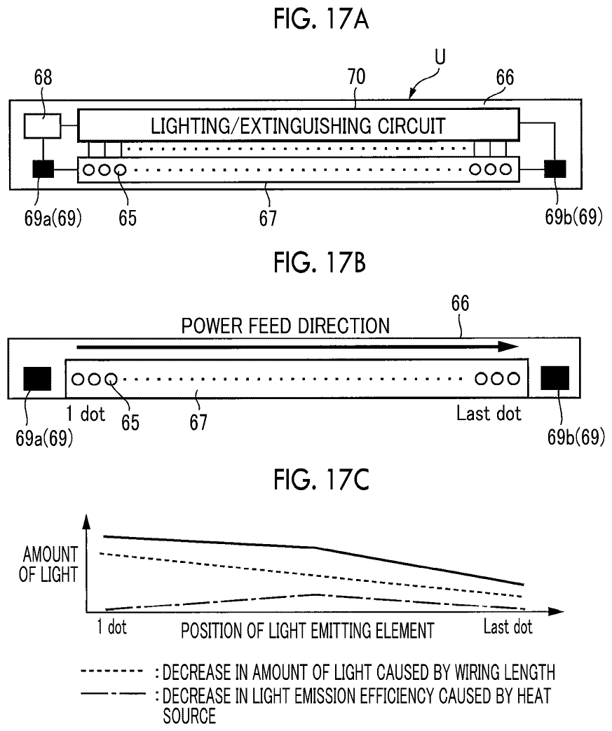

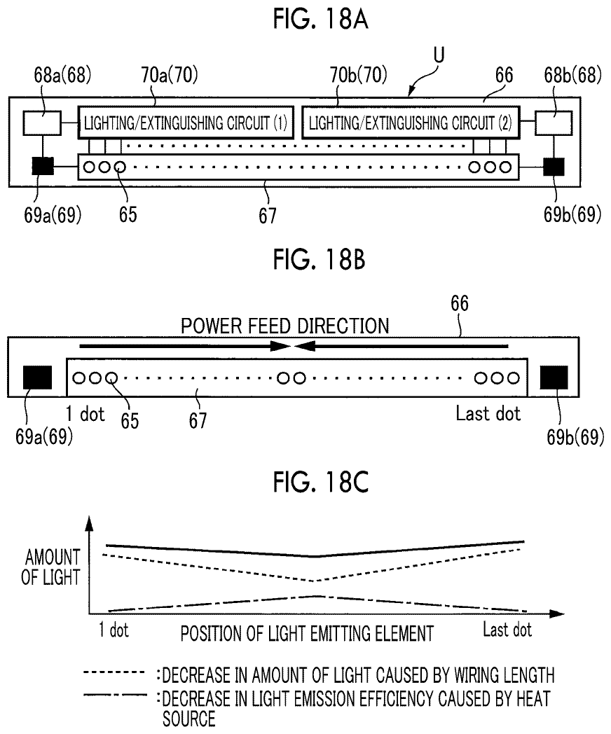

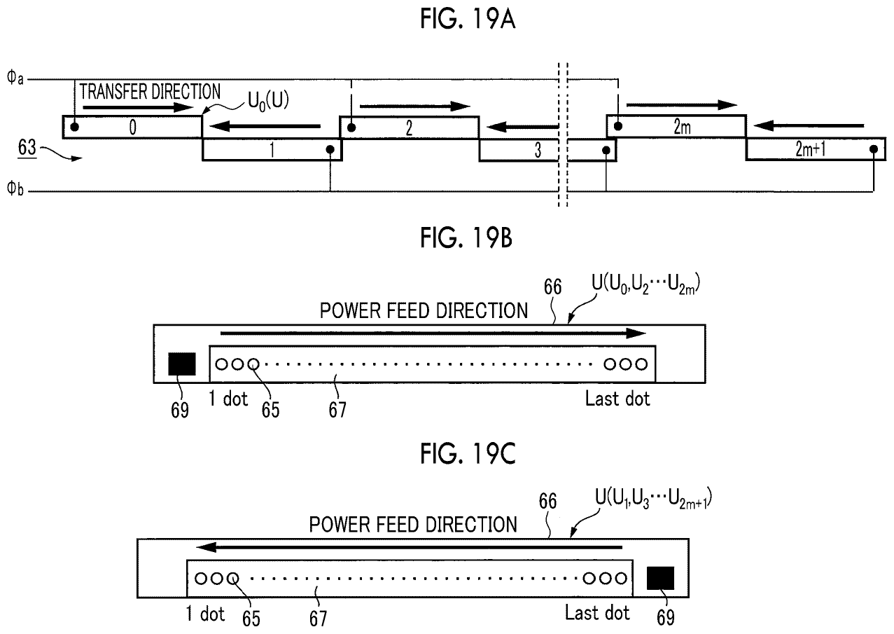

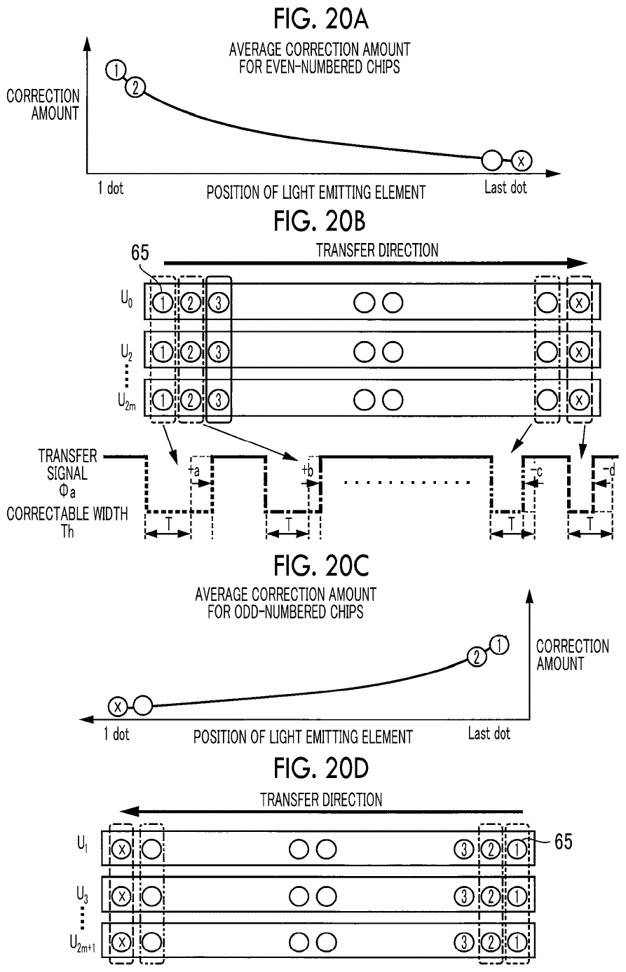

First, the LPH 60 is installed in the light profile measurement device, and each LED is turned on and the light amount distribution data of each LED is measured. Then, an integral value of the measured light amount distribution data in a direction (sub-scanning direction) orthogonal to the main scanning direction at each coordinate position in an arrangement direction of the LEDs (main scanning direction) is calculated to obtain a light amount distribution (light profile) in the main scanning direction (see FIG. 10A).

Subsequently, the amount of light from valley to valley in the light profile is integrated and this integral value is divided by a distance between the valleys, so that light amount (exposure energy) density in a region between the valleys is calculated. The exposure energy density in each region obtained in this way is used as a correction characteristic value of each LED. Then, to match this correction characteristic value to a predetermined target value, the amount of light increases or decreases according to an error between the correction characteristic value and the target value, so that the correction characteristic values in all regions become flat (FIG. 10B). After that, the light amount correction value of each region subjected to such flattening processing is set as the light amount correction value for each LED.

In a case where the amount of light is to be corrected for density unevenness in the present exemplary embodiment, a light emission time width t is increased (tL) or reduced (tS) at a predetermined light intensity Pc as shown in FIG. 10C to correct the amount of light.

### Reference Clock Generation Unit

The reference clock generation unit 116 generates a reference clock required for the signal generation circuit 100, and is connected to the image output control unit 40, the timing signal generation unit 114, and the lighting time control/drive units 118 (118-1 to 118-n).

Further, in the present exemplary embodiment, as shown in FIG. 2, a toner image as a test patch (density sample) is formed on the photoreceptor 24 of each image forming engine 23 at a predetermined timing, and a density detector 28 detects the density of the toner image. As shown in FIG. 6, toner image density data detected by the density detector 28 is output to the image output control unit 40. The image output control unit 40 calculates the amount of light at the LPH 60 from the input toner image density data to generate light amount adjustment data DT3. Then, the generated light amount adjustment data DT3 is output to the reference clock generation unit 116.

In the present exemplary embodiment, the density of the toner image formed as the test patch may vary. For example, a variation in the sensitivity of the photoreceptor 24, a variation in the potential of a latent image (the potential of a dark portion or the potential of a bright portion), a variation in the amount of developer in the developing unit 27, and the like are factors causing a variation in the density of the toner image. For this reason, in the present exemplary embodiment, the light amount adjustment data DT3 is data that is used to adjust the total amount of light at the LPH 60 (the amount of light emitted from all the LEDs in the LPH 60) in order to keep the above-mentioned variation constant. Therefore, the light amount adjustment data DT3 is output as an indication value that indicates a pulse width of a lighting signal ΦI for driving each light emitting element chip U of the LPH 60.

### Timing Signal Generation Unit

The timing signal generation unit 114 is connected to the image output control unit 40 and the reference clock generation unit 116. The timing signal generation unit 114 generates transfer signals CK1R and CK1C and transfer signals CK2R and CK2C in synchronization with the horizontal synchronization signal Lsync input from the image output control unit 40 based on a reference clock signal from the reference clock generation unit 116. Here, Lsync denotes a timing signal for providing a timing of the start of a single main scan period. The transfer signals CK1R and CK1C and the transfer signals CK2R and CK2C are converted into the first transfer signal Φ1 and the second transfer signal Φ2 by the level shift circuit 104 and the first transfer signal Φ1 and the second transfer signal Φ2 are transmitted to the light emitting element chip array 63.

Further, the timing signal generation unit 114 is connected to the density unevenness correction data unit 112 and the image data deployment unit 110. The timing signal generation unit 114 outputs a data readout signal for reading out the image data DTg corresponding to each pixel from the image data deployment unit 110 and a data readout signal for reading out the density unevenness correction data corresponding to each image (each LED) from the density unevenness correction data unit 112, in synchronization with the horizontal synchronization signal Lsync input from the image output control unit 40 based on the reference clock signal from the reference clock generation unit 116. Furthermore, the timing signal generation unit 114 is also connected to the lighting time control/drive units 118 (118-1 to 118-n). The timing signal generation unit 114 outputs a trigger signal TRG for starting to light the light emitting element chip array 63 based on the reference clock signal from the reference clock generation unit 116.

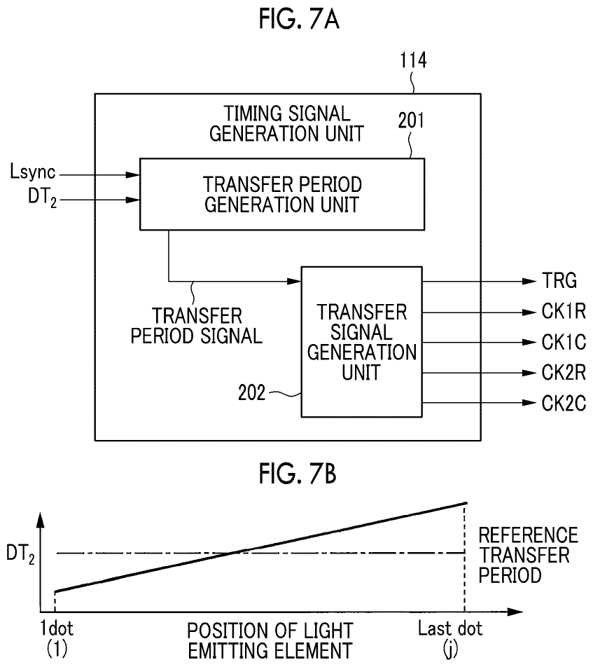

Further, as shown in FIG. 7A, the timing signal generation unit 114 includes a transfer period generation unit 201 and a transfer signal generation unit 202. The transfer period generation unit 201 generates a transfer period signal based on the horizontal synchronization signal Lsync and transfer period setting data DT2, and transmits the transfer period signal to the transfer signal generation unit 202. The transfer period signal mentioned herein is a signal that determines the rising and falling timings of the transfer signals CK1C and CK2C. The transfer signal generation unit 202 generates transfer signals CK1R, CK1C, CK2R, and CK2C based on the transfer period signal. Furthermore, the transfer signal generation unit 202 also generates the trigger signal TRG.

Here, supplementary description will be given regarding the transfer period setting data DT2.

The transfer period setting data DT2 is data for setting a transfer period TS of a driving signal for the light emitting element 65 of each of the light emitting element chips U (U1 to Un).

In general, the transfer period setting data DT2 is data in which a timing at which the lighting signal ΦI is transferred is set as a uniform reference transfer period TSc based on the process speed of the image forming system 20.

However, in the present exemplary embodiment, it has been found that the light emitting element chips U (U1 to Un) in which the plurality of light emitting elements 65 are arranged have a characteristic that the amount of light varies depending on the arrangement position of the light emitting element 65 even after density unevenness correction processing is performed.

For this reason, in the present exemplary embodiment, a method of making the transfer period vary for each light emitting element 65 in order to correct a variation in the amount of light depending on the arrangement position of the light emitting element 65 described above has been proposed. Further, in the present exemplary embodiment, the transfer period setting data DT2 is set to be used to set a transfer period that varies for each light emitting element 65. Details of this point will be described later.

### Lighting Time Control/Drive Unit

The lighting time control/drive units 118 (118-1 to 118-n) set the lighting times of the respective pixels (the respective LEDs) based on the image data DTg from the image data deployment unit 110. The lighting time control/drive units 118 (118-1 to 118-n) correct the lighting times of the respective pixels (the respective LEDs) based on the density unevenness correction data from the density unevenness correction data unit 112, and generate the lighting signals ΦI (ΦI1 to ΦIn) for lighting the respective pixels of the respective light emitting element chips U.

### Power Supply Voltage Control Unit

In the present exemplary embodiment, the power supply voltage control unit 101 controls a power supply voltage that is supplied to the LPH 60. Specifically, the power supply voltage control unit 101 is configured to include a three-terminal regulator 119 as shown in FIG. 6.

Here, the three-terminal regulator 119 generates a power supply voltage Vsub that is to be supplied to the light emitting element chip array 63.

In the present exemplary embodiment, the power supply voltage Vsub may be selected in advance, assuming a power supply voltage required for the light emitting element chip array 63. However, in an aspect in which a light intensity is also made to be variable in addition to making a light emission time width variable in a case of controlling the amount of light emitted from each light emitting element 65, it goes without saying that the power supply voltage Vsub is set to be variable in the power supply voltage control unit 101.

### Basic Configuration Example of Light Emitting Element Chip

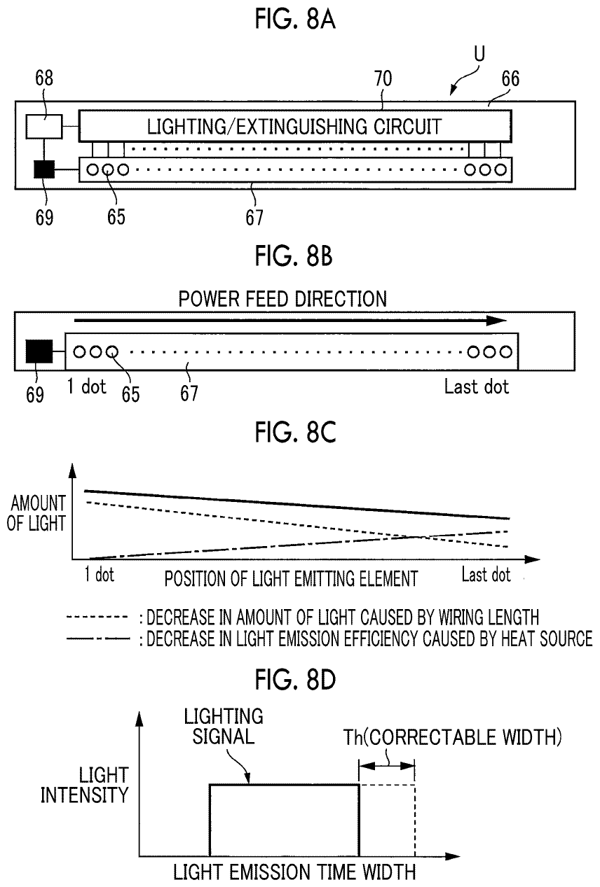

In the present exemplary embodiment, as shown in FIG. 8A, the light emitting element chip U includes a light emitting element array 67 extending in the main scanning direction on the chip substrate 66. The light emitting element array 67 is an array in which the plurality of light emitting elements 65 are arranged along the main scanning direction. In the present exemplary embodiment, a power feed pad 68 as a power feed unit to which various driving signals from the signal generation circuit 100 are supplied is provided on one side of the light emitting element array 67 in the main scanning direction on the chip substrate 66. Further, in the present exemplary embodiment, current limiting resistors 69 as resistance units are provided on one side of the light emitting element array 67 in the main scanning direction, which is a side identical to the power feed pad 68, on the chip substrate 66. The current limiting resistor 69 is to limit current that excessively flows to each light emitting element 65.

Furthermore, in the present exemplary embodiment, a lighting/extinguishing circuit 70 to which the various driving signals input to the power feed pad 68 are input and which sequentially turns on and off the respective light emitting elements 65 is provided on the chip substrate 66.

### Circuit Configuration Example of Light Emitting Element Chip

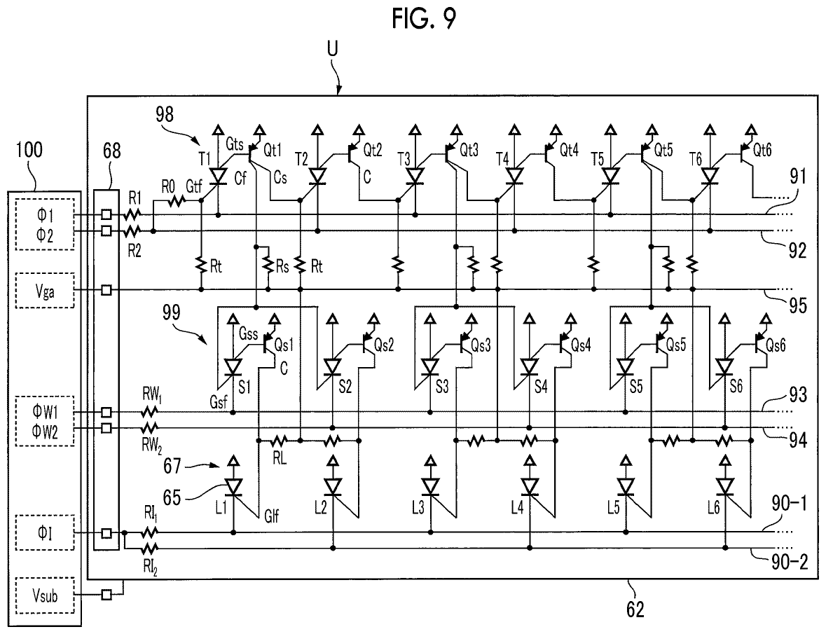

FIG. 9 shows a circuit configuration example of the light emitting element chip according to the first exemplary embodiment.

### Power Feed Pad

In the present exemplary embodiment, the power feed pad 68 includes terminals corresponding to a Φ1 terminal, a Φ2 terminal, a ΦW1 terminal, a ΦW2 terminal, a Vga terminal, and a ΦI terminal of the signal generation circuit 100, as shown in FIG. 9.

### Light Emitting Element Array

In FIG. 9, the light emitting element array 67 is an array in which the light emitting elements 65 consisting of light emitting thyristors L are arranged along the main scanning direction. That is, the light emitting element array 67 includes a light emitting thyristor row in which the light emitting thyristors L (L1, L2, L3, . . . ) as the light emitting elements 65 are sequentially arranged. In the present exemplary embodiment, the light emitting thyristor L is simple and preferable in that, for example, both the light emitting element array 67 and the lighting/extinguishing circuit 70 can be formed of thyristors, unlike the LED.

In the present exemplary embodiment, the light emitting thyristor L is a semiconductor element having a first gate, a second gate, an anode, and a cathode. In the present exemplary embodiment, the cathodes of odd-numbered light emitting thyristors L1, L3, L5, . . . are connected to a lighting signal line 90-1. Further, the lighting signal line 90-1 is connected to the ΦI terminal via the current limiting resistor 69. In FIG. 9, the current limiting resistor 69 is denoted by RI1.

On the other hand, the cathodes of even-numbered light emitting thyristors L2, L4, L6, . . . are connected to a lighting signal line 90-2. In the present exemplary embodiment, the lighting signal line 90-2 is connected in parallel to the lighting signal line 90-1. Further, the lighting signal line 90-2 is connected to the ΦI terminal via the current limiting resistor 69. Furthermore, the lighting signal ΦI is transmitted to the ΦI terminal. In FIG. 9, the current limiting resistor 69 is denoted by RI2.

### Lighting/Extinguishing Circuit

In the present exemplary embodiment, as shown in FIG. 9, the lighting/extinguishing circuit 70 includes a transfer thyristor row 98 and a write thyristor row 99.

Here, the transfer thyristor row 98 consists of transfer thyristors T (T1, T2, T3, . . . ) arranged in a row, similarly to the light emitting thyristor row as the light emitting element array 67.

In the present exemplary embodiment, in the transfer thyristor row 98, two transfer thyristors T1, T2, T3, . . . , are paired in order of numbers. The transfer thyristor row 98 includes coupling transistors Qt1, Qt2, Qt3, . . . which are pnp bipolar transistors between each pair.

On the other hand, the write thyristor row 99 consists of write thyristors S (S1, S2, S3, . . . ) arranged in a row, similarly to the light emitting thyristor row as the light emitting element array 67. The write thyristor row 99 includes write transistors Qs1, Qs2, Qs3, . . . corresponding to the write thyristors S1, S2, S3, . . . , respectively.

Further, a first transfer signal line 91 for transmitting the first transfer signal Φ1 and a second transfer signal line 92 for transmitting the second transfer signal Φ2 are formed on the surface of the chip substrate 66. Current limiting resistors R1 and R2 for preventing excessive current from flowing are connected in series to the first transfer signal line 91 and the second transfer signal line 92, respectively.

Furthermore, a first lighting start signal line 93 for transmitting a first lighting start signal ΦW 1 and a second lighting start signal line 94 for transmitting a second lighting start signal ΦW2 are formed on the surface of the chip substrate 66. Current limiting resistors RW1 and RW2 for preventing excessive current from flowing are connected in series to the first lighting start signal line 93 and the second lighting start signal line 94, respectively.

Here, each of the transfer thyristor T and the write thyristor S is a semiconductor element having a first gate, a second gate, an anode, and a cathode, similarly to the light emitting thyristor L. Further, each of the coupling transistor Qt and the write transistor Qs is a semiconductor element including a collector, a base, and an emitter, but the odd-numbered coupling transistor Qt includes two collectors (multi-collectors).

Furthermore, in FIG. 9, a first gate Gtf and a second gate Gts are used for the transfer thyristor T, a first gate Gsf and a second gate Gss are used for the write thyristor S, and a first gate Glf is used for the light emitting thyristor L. Similarly, a first collector Cf and a second collector Cs are used for the odd-numbered coupling transistor Qt including multi-collectors, and a collector C is used for the even-numbered coupling transistor Qt. In addition, a collector C is used for the write transistor Qs.

Next, the electrical connection of each element in the transfer thyristor row 98 and the write thyristor row 99 will be described (see FIG. 9).

### Transfer Thyristor Row

The anodes of the transfer thyristors T, the anodes of the write thyristors S, and the anodes of the light emitting thyristors L are connected to the chip substrate 66. Further, the emitters of the coupling transistors Qt and the emitters of the write transistors Qs are also connected to the chip substrate 66.

Furthermore, the anodes and the emitters are connected to a power line (not shown) via back surface electrodes that are Vsub terminals provided on the back surface of the chip substrate 66. A power supply voltage Vsub from the power supply voltage control unit 101 is supplied to the power line.

The cathodes of the odd-numbered transfer thyristors T1, T3, T5, . . . , are connected to the first transfer signal line 91 along the transfer thyristor row 98. The first transfer signal line 91 is connected to the Φ1 terminal via the current limiting resistor R1, and the first transfer signal Φ1 is transmitted to the first transfer signal line 91.

On the other hand, the cathodes of the even-numbered transfer thyristors T2, T4, T6, . . . , are connected to the second transfer signal line 92 along the transfer thyristor row 98. Further, the second transfer signal line 92 is connected to the Φ2 terminal via the current limiting resistor R2, and the second transfer signal Φ2 is transmitted to the second transfer signal line 92.

Furthermore, the first gates Gtf of the odd-numbered transfer thyristors T are connected to a power line 95 via resistors Rt along the transfer thyristor row 98. The second gates Gts are connected to the bases of the odd-numbered coupling transistors Qt. The power line 95 is connected to the Vga terminal.

The first collectors Cf of the odd-numbered coupling transistors Qt are connected to the power line 95 via resistors Rs. In addition, the first collector Cf corresponding to an odd number is connected to the first gate Gsf of each of the write thyristor S corresponding to an odd number identical to the odd number and the write thyristor S corresponding to an even number that is one greater than the odd number. The second collector Cs is connected to the first gate Gtf of the transfer thyristor T corresponding to an even number (rear stage) that is one greater than the odd number of the second collector Cs.

The first gates Gtf of the even-numbered transfer thyristors T are connected to the power line 95 for grounding via resistors Rt. The second gates Gts are connected to the bases of the even-numbered coupling transistors Qt. The collector C of the coupling transistor Qt corresponding to an even number is connected to the first gate Gtf of the transfer thyristor T corresponding to an odd number (next stage) that is one greater than the even number of the coupling transistor Qt.

### Write Thyristor Row

Further, the cathodes of the odd-numbered write thyristors S are connected to the first lighting start signal line 93 along the write thyristor row 99. Furthermore, the first lighting start signal line 93 is connected to the ΦW1 terminal via the current limiting resistor RW1, and the first lighting start signal ΦW1 is transmitted to the first lighting start signal line 93.

On the other hand, the cathodes of the even-numbered write thyristors S are connected to the second lighting start signal line 94 along the write thyristor row 99. The second lighting start signal line 94 is connected to the ΦW2 terminal via the current limiting resistor RW2, and the second lighting start signal ΦW2 is transmitted to the second lighting start signal line 94.

In addition, the second gates Gss of the write thyristors S are connected to the bases of the corresponding write transistors Qs, respectively. The collector C of the write transistor Qs is connected to the power line 95 via a resistor RL, and is connected to the first gate Glf of the light emitting thyristor L corresponding to a number identical to the number of the write transistor Qs.

As described above, in the light emitting element chip U according to the present exemplary embodiment, the write thyristor S corresponding to an odd number and the write thyristor S corresponding to a number, which is one greater than the odd number, are connected to the transfer thyristor T corresponding to a number identical to the odd number, and the light emitting thyristor L is connected to each write thyristor S. That is, the two light emitting thyristors L are controlled by the odd-numbered transfer thyristors T.

The odd-numbered coupling transistor Qt includes multi-collectors, but the odd-numbered coupling transistor Qt may include one collector and the first gate Gsf of the write thyristor S and the first gate Gtf of the transfer thyristor T may be commonly connected to the collector.

### Operation of Light Emitting Element Chip

In the present exemplary embodiment, the lighting control and the extinguishing control of each light emitting element 65 of the light emitting element array 67 are performed by the lighting/extinguishing circuit 70. For this reason, in the present exemplary embodiment, the respective light emitting elements 65 of the light emitting element array 67 are divided into the odd-numbered row group and the even-numbered row group and sequentially repeat the lighting and extinguishing operations in parallel.

In an aspect in which the lighting and extinguishing operations of the respective light emitting elements 65 of the light emitting element array 67 are performed in parallel in the groups as described above, it is possible to increase the speed of the writing operation of the light emitting element array 67 as compared to an aspect in which the respective light emitting elements 65 are not divided into groups.

An aspect in which the respective light emitting elements 65 of the light emitting element array 67 are divided into groups and repeat the lighting and extinguishing operations in parallel has been described in the present exemplary embodiment, but the present invention is not limited thereto. It goes without saying that the respective light emitting elements 65 may sequentially repeat the lighting and extinguishing operations without being divided into groups.

Further, an aspect in which the lighting/extinguishing circuit 70 includes the transfer thyristor row 98 and the write thyristor row 99 is used in the present exemplary embodiment, but the present invention is not limited thereto. For example, any unit that can realize the lighting and extinguishing operations for each light emitting element 65 may be appropriately selected as the lighting/extinguishing circuit 70.

### Behavior of Light Emitting Element Chip

As shown in FIGS. 8A and 9, the light emitting element chip U according to the present exemplary embodiment sequentially controls the lighting and extinguishing of the respective light emitting elements 65 from the power feed pad 68 via the lighting/extinguishing circuit 70.

For this reason, a power feed direction to the light emitting element chip U is a direction from the first light emitting element 65 (1 dot) close to the power feed pad 68 toward the last light emitting element 65 (Last dot) as shown in FIG. 8B.

Further, in the present exemplary embodiment, the light emitting element chip U includes the current limiting resistors 69 (RI1 and RI2) on one side of the light emitting element array 67 close to the power feed pad 68 in the main scanning direction.

In this case, the lighting signal line 90-1 and the first lighting start signal line 93 are energized in the present exemplary embodiment, in a case where the light emitting elements 65 of the odd-numbered rows are turned on. For this reason, current flows through the current limiting resistor 69 (RI1) connected to the lighting signal line 90-1, so that heat is generated.

Further, the lighting signal line 90-2 and the second lighting start signal line 94 are energized in a case where the light emitting elements 65 of the even-numbered rows are turned on. For this reason, current flows through the current limiting resistor 69 (RI2) connected to the lighting signal line 90-2, so that heat is generated.

### Influence on Optical Characteristics of Light Emitting Element Chip

In the present exemplary embodiment, a light amount distribution is measured for the light emitting element chip U on which light amount correction processing for density unevenness is performed as shown in FIG. 10B, so that a result shown in FIG. 8C is obtained.

According to FIG. 10B, it has been confirmed that the amount of variation in the amount of light varies depending on the arrangement position of the light emitting element 65 in the light emitting element chip U.

Specifically, there is a tendency in which the amount of light gradually decreases from the first light emitting element 65 (1 dot) to the last light emitting element 65 (Last dot) in the light emitting element array 67 of the light emitting element chip U.

The following factors are considered as factors causing a variation in the amount of light.

### (1) Influence of Power Feed Direction

In the present exemplary embodiment, the amount of light emitted from each light emitting element 65 gradually decreases in the power feed direction in the light emitting element array 67.

It is presumed that this depends on a distance or a wiring length between the power feed pad 68 and the light emitting element 65. That is, it is presumed that, as the distance or the wiring length between the power feed pad 68 and the light emitting element 65 is longer, the loss of supply current is larger, which causes a remarkable decrease in the amount of light (see a dotted line in FIG. 8C).

### (2) Influence of Current Limiting Resistor

In the present exemplary embodiment, the current limiting resistors 69 (RI1 and RI2) act as a heat source for the light emitting element array 67. In particular, since the first light emitting element 65 (1 dot) of the light emitting element array 67 is close to the current limiting resistors 69 (RI1 and RI2) in the present exemplary embodiment, the first light emitting element 65 is most likely to be affected by the action of the heat source. In general, it is known that the light emission efficiency of the light emitting element 65 decreases in a case where the temperature of the light emitting element 65 rises due to the action of the heat source. For this reason, it is presumed that a decrease in the amount of light in the present exemplary embodiment depends on a distance between the current limiting resistors 69 (RI1 and RI2) and the light emitting element 65. That is, it is presumed that, as the distance or the wiring length between the current limiting resistors 69 (RI1 and RI2) and the light emitting element 65 is shorter, a temperature rise caused by the heat source is more remarkable, which leads to a decrease in light emission efficiency (see a one-dot chain line in FIG. 8C).

Correction of variation in amount of light emitted from light emitting element chip

In order to correct a variation in the amount of light as shown in FIG. 8C, it is preferable that, for example, the amount of light correction of the last light emitting element 65 (Last dot) is allocated to be sufficiently larger than the amount of light correction of the first light emitting element 65 (1 dot).

That is, as shown in FIG. 8D, a correctable width Th of a light emission time width of the lighting signal ΦI may be increased in the light emitting element 65 of which the amount of light correction is predicted to be large. On the other hand, the correctable width Th of the light emission time width of the lighting signal ΦI may be reduced in the light emitting element 65 of which the amount of light correction is predicted to be small.

### Transfer Period of Driving Signal for Each Light Emitting Element

In general, a transfer period TS of a driving signal for each light emitting element 65 is uniquely determined depending on the process speed of the image forming system 20.

Here, a case is assumed in which the transfer period TS of the driving signal for each light emitting element 65 is, for example, TSa as shown in a part (a) in FIG. 11.

In this case, the first transfer signal Φ1 or the second transfer signal Φ2 is given to the light emitting element chip U, for example, every transfer period TSa (Duty 50%).

The lighting signal ΦI of the light emitting element 65 is created from a lighting start signal ΦW (specifically, the first lighting start signal ΦW1 and the second lighting start signal ΦW2) and a lighting end signal ΦR.

In this case, the driving ranges of the lighting start signal ΦW and the lighting end signal ΦR are limited as follows due to a ASIC function constraint.

In the present exemplary embodiment, the first half of the transfer period TSa of the first transfer signal Φ1 or the second transfer signal Φ2 is set as a ΦW drivable range of the lighting start signal ΦW. On the other hand, the latter half of the transfer period TSa is set as a ΦR drivable range of the lighting end signal ΦR. In the present exemplary embodiment, the ΦW drivable range and the ΦR drivable range are an identical range, and the ΦW drivable range corresponds to the correctable width Th described above.

Next, a case where the writing speed of the light emitting element chip U (corresponding to the process speed of the image forming system) is increased will be described.

In this case, as shown in a part (b) in FIG. 11, the transfer period TS of the driving signal for each light emitting element 65 may be selected to be TSb shorter than TSa.

In this case, as the transfer period TSb is shortened, the ΦW drivable range of the lighting start signal ΦW and the ΦR drivable range of the lighting end signal ΦR are narrowed. As a result, the correctable width Th is reduced.

In particular, in a case where the writing speed of the light emitting element chip U is to be increased, a method of uniformly setting the correctable width Th for each light emitting element 65 is not preferable.

In a case where the correctable width Th is uniformly set for each light emitting element 65, the correctable width Th is reduced. In this case, the correction of the amount of light may be insufficient for the light emitting element 65 of which the amount of light correction is predicted to be large.

In view of such a situation, the following correction method is employed in the present exemplary embodiment.

Example of Correction Method for Variation in Amount of Light Emitted from Light Emitting Element Chip

Here, the light emitting element chip U has a characteristic in which the amount of light gradually decreases from the first light emitting element 65 (1 dot) to the last light emitting element 65 (Last dot) in the light emitting element array 67 as shown in FIG. 8C.

For this reason, in the present exemplary embodiment, in order to correct a variation in the amount of light shown in FIG. 8C, a correction amount for increasing the correctable width Th as shown in a part (a) in FIG. 12 is selected for the light emitting element 65 of which the amount of light correction is predicted to be large (a right half region of the light emitting element array 67 with the middle as a boundary). In contrast, a correction amount for reducing the correctable width Th is selected for the light emitting element 65 of which the amount of light correction is predicted to be small (a left half region of the light emitting element array 67 with the middle as a boundary). The correction amount mentioned herein means an average correction amount per light emitting element chip U.

Here, it is assumed that the number j of the light emitting elements 65 of the light emitting element array 67 is, for example, 512 and the correctable width Th in the case of the reference transfer period is T.

Since a correction amount for the first light emitting element is the smallest, the correctable width Th is reduced to T-a as shown in a part (b) in FIG. 12.

Further, since a correction amount for the N-th light emitting element in the left half region with respect to a middle position is also small, the correctable width Th is reduced to T−b (a>b) as shown in the part (b) in FIG. 12.

Furthermore, since a large correction amount is required for the (512−N)th light emitting element in the right half region with respect to the middle position, the correctable width Th is increased to T+c as shown in the part (b) in FIG. 12.

In addition, since the largest correction amount is required for the 512th light emitting element, the correctable width Th is increased to T+d (d>c) as shown in the part (b) in FIG. 12.

In a case where the correctable widths Th of the respective light emitting elements are added up, the total of the correctable widths Th may be equal to the correctable width T of the reference transfer period×j (j=512).

Specifically, in a case where the correctable width Th is corrected for each light emitting element 65, a first correctable width group making the correctable width Th larger than a reference value (reference transfer period TSc/2) and a second correctable width group making the correctable width Th smaller than the reference value may be provided and the correctable width Th may be corrected such that a total value of differences between the first correctable width group and the reference value and a total value of differences between the second correctable width group and the reference value are substantially equal to each other.

In the present exemplary embodiment, for example, a method of increasing the transfer period TS of a driving signal for each light emitting element 65 is employed to increase the correctable width Th of the light emission time width of the lighting signal ΦI. On the other hand, in a case where the correctable width Th is to be reduced, for example, a method of reducing the transfer period TS of the driving signal for each light emitting element 65 is employed.

In the present exemplary embodiment, appropriate transfer period setting data DT2 for each light emitting element 65 of the light emitting element array 67 is selected based on correction characteristics shown in the part (a) in FIG. 12 (see FIG. 7B). The transfer period setting data DT2 are stored in the EEPROM 102 in a readable manner (see FIG. 6). The transfer period setting data DT2 is read out from the EEPROM 102 to the image output control unit 40, and then transmitted to the timing signal generation unit 114 of the signal generation circuit 100. After that, the transfer signals CK1R, CK1C, CK2R, and CK2C in consideration of the transfer period setting data DT2 are output from the timing signal generation unit 114, and the first transfer signal Φ1 and the second transfer signal Φ2 are generated.

### Relationship Between Transfer Signal and Lighting Signal of Light Emitting Element Array

In the present exemplary embodiment, the light emitting element chip U includes the light emitting element array 67 in which j light emitting elements 65 are arranged.

In the present exemplary embodiment, the transfer signals (the first transfer signal Φ1, the second transfer signal Φ2) are transmitted to the light emitting element chip U for each of the transfer periods TS (TS1, TS2, TS3, . . . , TSj−1, TSj) corrected based on the transfer period setting data DT2 (see FIG. 13A).

The lighting signal ΦI is output corresponding to the transfer period TS.

In this case, a decrease in the amount of light caused by the power feed direction (wiring length) or a decrease in the light emission efficiency of the light emitting element using the current limiting resistors 69 as a heat source may occur in the light emitting element chip U. However, since the correctable width Th is ensured sufficiently and corrected in the present exemplary embodiment for a light emitting element group of which the amount of light correction is predicted to be large, the correction of the amount of light described above is appropriately performed.

Further, a writing operation for one line of the light emitting element chip U is performed within a total time of the transfer periods TS of the transfer signals of the respective light emitting elements 65. In this case, the total time of the transfer periods TS is TS1+TS2+ . . . +TSj−1+TSj=j×TSc (TSc: reference transfer period).

Accordingly, in the present exemplary embodiment, the writing processing of the light emitting element chip U can be performed within a predetermined period, and a variation in the amount of light caused by the power feed direction or the current limiting resistors 69 can also be appropriately corrected.

### First Comparative Exemplary Embodiment

In a light emitting element chip U′ according to a first comparative exemplary embodiment, transfer signals Φ1′ having an identical reference transfer period TSc are used for all light emitting elements.

In the present exemplary embodiment, a writing operation for one line of the light emitting element chip U′ is performed within a total time (j×TSc) of the reference transfer periods TSc of the transfer signals of the respective light emitting elements 65.

However, the following problems may occur in a case where the writing speed of the light emitting element chip U is increased in the present exemplary embodiment. For example, even though a decrease in the amount of light caused by the power feed direction (wiring length) or a decrease in the light emission efficiency of the light emitting element using the current limiting resistors 69 as a heat source occurs, a correctable width Th cannot be ensured sufficiently for a light emitting element group of which the amount of light correction is predicted to be large. For this reason, it may be difficult to appropriately correct a variation in the amount of the light.

### Second Exemplary Embodiment

FIG. 14A shows a configuration example of a light emitting element chip according to a second exemplary embodiment.

In FIG. 14A, the light emitting element chip U includes a light emitting element array 67, a power feed pad 68, current limiting resistors 69, and a lighting/extinguishing circuit 70 on a chip substrate 66, as in the first exemplary embodiment.

However, in the light emitting element chip U according to the present exemplary embodiment, unlike in the first exemplary embodiment, the power feed pad 68 is provided on one side of the light emitting element array 67 close to the last light emitting element 65 (Last dot). Further, the current limiting resistors 69 are also provided on one side of the light emitting element array 67 close to the last light emitting element 65 (Last dot).

In the present exemplary embodiment, a power feed direction to the light emitting element array 67 is a direction opposite to the power feed direction in the first exemplary embodiment and lighting and extinguishing operations are sequentially performed from the last light emitting element 65 (Last dot) to the first light emitting element 65 (1 dot).

Furthermore, since the last light emitting element 65 (Last dot) of the light emitting element array 67 is close to the current limiting resistors 69 (RI1 and RI2) in the present exemplary embodiment, the last light emitting element 65 is most likely to be affected by the action of a heat source.

According to FIG. 14C, it is confirmed that the amount of light emitted from each light emitting element 65 gradually decreases from the side of the last light emitting element 65 (Last dot) in the power feed direction. In the present exemplary embodiment as well, it is presumed that a decrease in the amount of light caused by a distance or a wiring length between the power feed pad 68 and the light emitting element 65 and a decrease in light emission efficiency caused by a distance between the current limiting resistors 69 as a heat source and each light emitting element 65 affect a variation in the amount of light described above, as in the first exemplary embodiment.

Here, the light emitting element chip U has a characteristic in which the amount of light gradually decreases from the last light emitting element 65 (Last dot) to the first light emitting element 65 (1 dot) in the light emitting element array 67 as shown in FIG. 14C.

For this reason, in the present exemplary embodiment, in order to correct a variation in the amount of light shown in FIG. 14C, a correction amount for increasing the correctable width Th as shown in a part (a) in FIG. 15 is selected for the light emitting element 65 of which the amount of light correction is predicted to be large (a left half region of the light emitting element array 67 with the middle as a boundary). In contrast, the correctable width Th is reduced for the light emitting element 65 of which the amount of light correction is predicted to be small (a right half region of the light emitting element array 67 with the middle as a boundary).

Here, it is assumed that the number j of the light emitting elements 65 of the light emitting element array 67 is, for example, 512 and the correctable width Th in the case of the reference transfer period is T.

Since a correction amount for the last 512th light emitting element is the smallest, the correctable width Th is reduced to T-a as shown in a part (b) in FIG. 15.

Further, since a correction amount for the (512−N)th light emitting element in the right half region with respect to a middle position is also small, the correctable width Th is reduced to T−b (a>b) as shown in the part (b) in FIG. 15.

Furthermore, since a large correction amount is required for the N-th light emitting element in the left half region with respect to the middle position, the correctable width Th is increased to T+c as shown in the part (b) in FIG. 15.

In addition, since the largest correction amount is required for the first light emitting element, the correctable width Th is increased to T+d (d>c) as shown in the part (b) in FIG. 15.

In a case where the correctable widths Th of the respective light emitting elements are added up, the total of the correctable widths Th may be equal to the correctable width T of the reference transfer period×j (j=512).

### Third Exemplary Embodiment

FIG. 16A shows a configuration example of a light emitting element chip according to a third exemplary embodiment.

In FIG. 16A, the light emitting element chip U includes a light emitting element array 67, a power feed pad 68, current limiting resistors 69, and a lighting/extinguishing circuit 70 on a chip substrate 66, as in the first and second exemplary embodiments.

However, in the light emitting element chip U according to the present exemplary embodiment, unlike in the first and second exemplary embodiments, the power feed pad 68 is provided on one side of the light emitting element array 67 close to the first light emitting element 65 (1 dot). Further, the current limiting resistors 69 are provided on one side of the light emitting element array 67 that is close to the last light emitting element 65 (Last dot) and opposite to the power feed pad 68.

In the present exemplary embodiment, as shown in FIG. 16B, a power feed direction to the light emitting element array 67 is identical to the power feed direction in the first exemplary embodiment and lighting and extinguishing operations are sequentially performed from first light emitting element 65 (1 dot) to the last light emitting element 65 (Last dot).

Furthermore, since the last light emitting element 65 (Last dot) of the light emitting element array 67 is close to the current limiting resistors 69 (RI1 and RI2) in the present exemplary embodiment, the last light emitting element 65 is most likely to be affected by the action of a heat source.

According to FIG. 16C, as in the first exemplary embodiment, it is confirmed that the amount of light emitted from each light emitting element 65 gradually decreases from the side of the first light emitting element 65 (1 dot) in the power feed direction. However, in the present exemplary embodiment, unlike in the first exemplary embodiment, both a graph of a decrease in the amount of light caused by a distance or a wiring length between the power feed pad 68 and the light emitting element 65 and a graph of a decrease in light emission efficiency caused by a distance between the current limiting resistors 69 as a heat source and each light emitting element 65 tend to be inclined to an upper left side in FIG. 16C. For this reason, the amount of variation in the amount of light described above more remarkably appears on the side of the last light emitting element 65 (Last dot) as compared to the first exemplary embodiment.

Accordingly, in a case where such a variation in the amount of light is to be corrected in the present exemplary embodiment, correction having characteristics identical to characteristics in the first exemplary embodiment may be performed but it is necessary to select a correction amount to be larger than the correction amount in the first exemplary embodiment as appropriate.

### Fourth Exemplary Embodiment

FIG. 17A shows a configuration example of a light emitting element chip according to a fourth exemplary embodiment.

In FIG. 17A, the light emitting element chip U includes a light emitting element array 67, a power feed pad 68, current limiting resistors 69, and a lighting/extinguishing circuit 70 on a chip substrate 66, as in the first to third exemplary embodiments.

However, in the light emitting element chip U according to the present exemplary embodiment, unlike the first to third exemplary embodiments, the power feed pad 68 is provided on one side of the light emitting element array 67 close to the first light emitting element 65 (1 dot). Further, the light emitting element chip U includes a pair of current limiting resistors 69 (69a and 69b) on both sides of the light emitting element array 67 in the main scanning direction.

In the present exemplary embodiment, as shown in FIG. 17B, a power feed direction to the light emitting element array 67 is identical to the power feed direction in the first exemplary embodiment, and lighting and extinguishing operations are sequentially performed from first light emitting element 65 (1 dot) to the last light emitting element 65 (Last dot).

Further, since the first light emitting element 65 (1 dot) and the last light emitting element 65 (Last dot) of the light emitting element array 67 are close to the current limiting resistors 69 (69a and 69b) in the present exemplary embodiment, the first light emitting element 65 and the last light emitting element 65 are most likely to be affected by the action of a heat source.

According to FIG. 17C, it is confirmed that the amount of light emitted from each light emitting element 65 gradually decreases from the side of the first light emitting element 65 (1 dot) in the power feed direction. However, in the present exemplary embodiment, a graph of a decrease in the amount of light caused by the power feed direction (wiring length) tends to be inclined to a lower right side from the first light emitting element 65 (1 dot) to the last light emitting element 65 (Last dot) (see a dotted line in FIG. 17C). Meanwhile, since the pair of current limiting resistors 69 is provided, the first light emitting element 65 (1 dot) and the last light emitting element 65 (Last dot) are most strongly affected by the heat source. In contrast, the light emitting element 65 positioned near the middle of the light emitting element array 67 in the main scanning direction is less likely to be affected by the heat source. For this reason, a graph of characteristics of a decrease in light emission efficiency caused by the heat source tends to have a mountain shape such that a decrease in light emission efficiency caused by the heat source is reduced in the middle of the light emitting element array 67 (see a one-dot chain line in FIG. 17C).

Therefore, in the present exemplary embodiment, a graph of a decrease in the amount of light emitted from the light emitting element array 67 tends to be inclined to a lower right side while having a bending point near the middle of the light emitting element array 67 in the main scanning direction.

Accordingly, in a case where such a variation in the amount of light is to be corrected in the present exemplary embodiment, a correction amount may be appropriately selected in consideration of the variation characteristics of the amount of light shown in FIG. 17C.

### Fifth Exemplary Embodiment

FIG. 18A shows a configuration example of a light emitting element chip according to a fifth exemplary embodiment.

In FIG. 18A, the light emitting element chip U includes a light emitting element array 67, power feed pads 68, current limiting resistors 69, and a lighting/extinguishing circuit 70 on a chip substrate 66, as in the first to fourth exemplary embodiments.

However, unlike in the first to fourth exemplary embodiments, the light emitting element chip U according to the present exemplary embodiment includes a pair of power feed pads 68 (68a and 68b) on both sides of the light emitting element array 67 in the main scanning direction. The lighting/extinguishing circuit 70 includes a lighting/extinguishing circuit (1) 70a to which power is fed from the power feed pad 68a and a lighting/extinguishing circuit (2) 70b to which power is fed from the power feed pad 68b. In the present exemplary embodiment, the lighting/extinguishing circuit (1) 70a is responsible for a left half region with the middle of a light emitting element group of the light emitting element array 67 as a boundary. On the other hand, the lighting/extinguishing circuit (2) 70b is responsible for a right half region with the middle of the light emitting element group of the light emitting element array 67 as a boundary. Further, the light emitting element chip U includes a pair of current limiting resistors 69 (69a and 69b) on both sides of the light emitting element array 67 in the main scanning direction.

In the present exemplary embodiment, as shown in FIG. 18B, a power feed direction to the light emitting element array 67 is a direction from both ends of the light emitting element array 67 toward the middle in the main scanning direction, and lighting and extinguishing operations are sequentially performed along the power feed direction.

Further, since the first light emitting element 65 (1 dot) and the last light emitting element 65 (Last dot) of the light emitting element array 67 are close to the current limiting resistors 69 (69a and 69b) in the present exemplary embodiment, the first light emitting element 65 and the last light emitting element 65 are most likely to be affected by the action of a heat source.

According to FIG. 18C, it is confirmed that the amount of light emitted from each light emitting element 65 gradually decreases along the power feed direction from end portions of the light emitting element array 67 toward the middle in the main scanning direction. For this reason, in the present exemplary embodiment, the amount of light tends to decrease in the middle portion of the light emitting element array 67 compared to the end portions.

Here, a graph of a decrease in the amount of light caused by the power feed direction (wiring length) tends to have a V shape in which a peak is formed in the middle of the light emitting element array 67 in the main scanning direction (see a dotted line in FIG. 18C). Further, since the pair of current limiting resistors 69 (69a and 69b) is provided, the first light emitting element 65 (1 dot) and the last light emitting element 65 (Last dot) are most strongly affected by the heat source. In contrast, the light emitting element 65 positioned near the middle of the light emitting element array 67 in the main scanning direction is less likely to be affected by the heat source. For this reason, a graph of characteristics of a decrease in light emission efficiency caused by the heat source tends to have a mountain shape such that a decrease in light emission efficiency caused by the heat source is reduced in the middle of the light emitting element array 67 (see a one-dot chain line in FIG. 18C).

Therefore, in the present exemplary embodiment, a graph of a decrease in the amount of light emitted from the light emitting element array 67 tends to change in a V shape while having a bending point near the middle of the light emitting element array 67 in the main scanning direction.

Accordingly, in a case where such a variation in the amount of light is to be corrected in the present exemplary embodiment, a correction amount may be appropriately selected in consideration of the variation characteristics of the amount of light shown in FIG. 18C.

### Sixth Exemplary Embodiment

FIG. 19A shows a configuration example of a light emitting element chip array 63 according to a sixth exemplary embodiment.

In the present exemplary embodiment, the light emitting element chip array 63 is an array in which a plurality of light emitting element chips U (U0 to U2m+1) are arranged in a staggered pattern on a circuit board 62 (see FIG. 4A) as in the first exemplary embodiment.

In the present exemplary embodiment, each of the light emitting element chips U (specifically, U0, U2, . . . , U2m) of even-numbered rows includes a light emitting element array 67, a power feed pad (not shown), current limiting resistors 69, and a lighting/extinguishing circuit (not shown) on a chip substrate 66 as shown in FIG. 19B.

In the present exemplary embodiment, a power feed direction to the light emitting element array 67 is a direction from the first light emitting element 65 (1 dot) toward the last light emitting element 65 (Last dot). Further, the current limiting resistors 69 are provided on one side of the light emitting element array 67 close to the first light emitting element 65 (1 dot) in the main scanning direction.

Furthermore, each of the light emitting element chips U (specifically, U1, U3, . . . , U2m+1) of odd-numbered rows includes a light emitting element array 67, a power feed pad (not shown), current limiting resistors 69, and a lighting/extinguishing circuit (not shown) on a chip substrate 66 as shown in FIG. 19C.

In the present exemplary embodiment, a power feed direction to the light emitting element array 67 is a direction from the last light emitting element 65 (Last dot) toward the first light emitting element 65 (1 dot). In addition, the current limiting resistors 69 are provided on one side of the light emitting element array 67 close to the last light emitting element 65 (Last dot) in the main scanning direction.

In the present exemplary embodiment, the light emitting element chips U (U0, U2, . . . , U2m) of the even-numbered rows are grouped into sets, and each of the light emitting element chips U (U0, U2, . . . , U2m) is controlled using a transfer signal Φa as a common signal.

Further, the light emitting element chips U (U1, U3, . . . , U2m+1) of the odd-numbered rows are also grouped into sets, and each of the light emitting element chips U (U1, U3, . . . , U2m+1) is controlled by a transfer signal Φb as a common signal.

FIG. 20A shows a relationship between a correction amount for a variation in the amount of light emitted from the light emitting element chips U (U0, U2, . . . , U2m) of the even-numbered rows and the position of each light emitting element. According to FIG. 20A, the correction amount for the first light emitting element 65 (1 dot) of the light emitting element array 67 is set to be the largest and the correction amount for the last light emitting element 65 (Last dot) is set to be the smallest. The correction amount mentioned herein means an average correction amount for the light emitting element chips U of the even-numbered rows (even-numbered chips).

FIG. 20B shows a correction processing example for a variation in the amount of light emitted from the light emitting element chips U (U0, U2, . . . , U2m) of the even-numbered rows. According to FIG. 20B, the transfer signals Φa are sequentially supplied from the first light emitting element 65 (1 dot) to the last light emitting element 65 (Last dot), and each light emitting element chip U repeats lighting and extinguishing operations in parallel. In this case, the transfer signal Φa is supplied in a state where the transfer period TS based on the transfer period setting data DT2 (including the correction amount) is increased or reduced.

FIG. 20C shows a relationship between a correction amount for a variation in the amount of light emitted from the light emitting element chips U (U1, U3, . . . , U2m+1) of the odd-numbered rows and the position of each light emitting element. According to FIG. 20C, the correction amount for the last light emitting element 65 of the light emitting element array 67 is set to be the largest and the correction amount for the first light emitting element 65 (1 dot) is set to be the smallest. The correction amount mentioned herein means an average correction amount for the light emitting element chips U of the odd-numbered rows (odd-numbered chips).

FIG. 20D shows a correction processing example for a variation in the amount of light emitted from the light emitting element chips U (U1, U3, . . . , U2m+1) of the odd-numbered rows. According to FIG. 20D, the transfer signals Φb are sequentially supplied in a direction in which the last light emitting element 65 (Last dot) is set as the first and the first light emitting element 65 (1 dot) is set as the last, and each light emitting element chip U repeats lighting and extinguishing operations in parallel. In this case, the transfer signal Φb is supplied in a state where the transfer period TS based on the transfer period setting data DT2 (including the correction amount) is increased or reduced.

### Supplementary Note

(((1)))

A light emitting device comprising:
a light source unit in which a plurality of light emitting elements are arranged on a substrate along a main scanning direction; and
a drive unit that drives the plurality of light emitting elements to cause the plurality of light emitting elements to emit light at different timings within a predetermined certain period while changing light emission time widths based on the amount of light to be emitted,
wherein the drive unit includes a correction unit that corrects the light emission time width within a range of a correctable width, which is a range in which the light emission time width is correctable, to make the correctable width vary for each light emitting element.
   (((2)))

The light emitting device according to (((1))),
wherein the correction unit corrects the correctable width such that the correctable width for the light emitting element of which the amount of variation in the amount of light is predicted to be large among the light emitting elements is larger than the correctable width for the light emitting element of which the amount of variation in the amount of light is predicted to be small.
   (((3)))

The light emitting device according to (((2))),
wherein the correction unit corrects the correctable width such that the correctable width for the light emitting element of which the amount of variation in the amount of light is predicted to be larger than a predetermined reference amount of variation among the light emitting elements is larger than a predetermined reference value, and corrects the correctable width such that the correctable width for the light emitting element of which the amount of variation in the amount of light is predicted to be smaller than the reference amount of variation is smaller than the reference value.
   (((4)))

The light emitting device according to any one of (((1))) to (((3))), further comprising:
a power feed unit that is provided on a side of an end portion of the light source unit in the main scanning direction on the substrate and feeds power to each light emitting element,
wherein the correction unit makes the correctable width vary depending on a distance or a wiring length between the power feed unit and the light emitting element.
   (((5)))

The light emitting device according to (((4))),
wherein the correction unit corrects the correctable width such that the correctable width is larger as the distance or the wiring length between the power feed unit and the light emitting element is longer.
   (((6)))

The light emitting device according to any one of (((1))) to (((3))), further comprising:
a resistance unit that is provided on a side of an end portion of the light source unit in the main scanning direction on the substrate and limits current to be supplied to the light emitting element,
wherein the correction unit makes the correctable width for the light emitting element vary depending on a distance between the resistance unit and the light emitting element.
   (((7)))

The light emitting device according to (((6))),
wherein the correction unit corrects the correctable width such that the correctable width of the amount of light emitted from the light emitting element is larger as the distance between the resistance unit and the light emitting element is shorter.
   (((8)))

The light emitting device according to any one of (((1))) to (((3))), further comprising:
a power feed unit that is provided on a side of an end portion of the light source unit in the main scanning direction on the substrate and feeds power to each light emitting element; and
a resistance unit that is provided on a side of an end portion of the light source unit in the main scanning direction on the substrate and limits current to be supplied to the light emitting element,
wherein the power feed unit is disposed on one side of the light source unit opposite to the resistance unit, and
the correction unit makes the correctable width vary depending on a distance or a wiring length between the power feed unit and the light emitting element and a distance between the resistance unit and the light emitting element.
   (((9)))

The light emitting device according to (((3))),
wherein, in a case where the correction unit corrects the correctable width for each light emitting element, the correction unit includes a first correctable width group making the correctable width larger than the reference value and a second correctable width group making the correctable width smaller than the reference value, and corrects the correctable width such that a total value of differences between the first correctable width group and the reference value and a total value of differences between the second correctable width group and the reference value are substantially equal to each other.
   (((10)))

The light emitting device according to any one of (((1))) to (((9))),
wherein the plurality of light emitting elements of the light source unit are divided and arranged in a plurality of sets, and
the correction unit makes the correctable width vary in parallel for each of the light emitting elements that are divided into the sets.
   (((11)))

The light emitting device according to (((10))),
wherein the light source unit consists of a plurality of systems that use a common driving signal for each identical set, and
the correction unit performs processing of correcting the correctable width for the light emitting element belonging to any one set of systems and processing of correcting the correctable width for the light emitting element belonging to another set of systems in parallel.
   (((12)))

An optical writing device comprising:
the light emitting device according to any one of (((1))) to (((11))) that is provided to face an image holding unit on which an image formed using light is capable of being held; and
an imaging unit that forms an image on the image holding unit using light emitted from each light emitting element of the light emitting device,
wherein the image formed using the light is written on the image holding unit.
   (((13)))

An image forming system comprising:
an image holding unit on which an image formed using light is capable of being held; and
the optical writing device according to (((12))),
wherein the image formed using the light and held on the image holding unit is visualized and output.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light emitting device comprising:
a light source unit in which a plurality of light emitting elements are arranged on a substrate along a main scanning direction; and
a drive unit that drives the plurality of light emitting elements to cause the plurality of light emitting elements to emit light at different timings within a predetermined certain period while changing light emission time widths based on the amount of light to be emitted,
wherein the drive unit includes a correction unit that corrects the light emission time width within a range of a correctable width, which is a range in which the light emission time width is correctable, to make the correctable width vary for each light emitting element.

2. The light emitting device according to claim 1,
wherein the correction unit corrects the correctable width such that the correctable width for the light emitting element of which the amount of variation in the amount of light is predicted to be large among the light emitting elements is larger than the correctable width for the light emitting element of which the amount of variation in the amount of light is predicted to be small.

3. The light emitting device according to claim 2,
wherein the correction unit corrects the correctable width such that the correctable width for the light emitting element of which the amount of variation in the amount of light is predicted to be larger than a predetermined reference amount of variation among the light emitting elements is larger than a predetermined reference value, and corrects the correctable width such that the correctable width for the light emitting element of which the amount of variation in the amount of light is predicted to be smaller than the reference amount of variation is smaller than the reference value.

4. The light emitting device according to claim 1, further comprising:
a power feed unit that is provided on a side of an end portion of the light source unit in the main scanning direction on the substrate and feeds power to each light emitting element,
wherein the correction unit makes the correctable width vary depending on a distance or a wiring length between the power feed unit and the light emitting element.

5. The light emitting device according to claim 4,
wherein the correction unit corrects the correctable width such that the correctable width is larger as the distance or the wiring length between the power feed unit and the light emitting element is longer.

6. The light emitting device according to claim 1, further comprising:
a resistance unit that is provided on a side of an end portion of the light source unit in the main scanning direction on the substrate and limits current to be supplied to the light emitting element,
wherein the correction unit makes the correctable width for the light emitting element vary depending on a distance between the resistance unit and the light emitting element.

7. The light emitting device according to claim 6,
wherein the correction unit corrects the correctable width such that the correctable width of the amount of light emitted from the light emitting element is larger as the distance between the resistance unit and the light emitting element is shorter.

8. The light emitting device according to claim 1, further comprising:
a power feed unit that is provided on a side of an end portion of the light source unit in the main scanning direction on the substrate and feeds power to each light emitting element; and
a resistance unit that is provided on a side of an end portion of the light source unit in the main scanning direction on the substrate and limits current to be supplied to the light emitting element,
wherein the power feed unit is disposed on one side of the light source unit opposite to the resistance unit, and
the correction unit makes the correctable width vary depending on a distance or a wiring length between the power feed unit and the light emitting element and a distance between the resistance unit and the light emitting element.

9. The light emitting device according to claim 3,
wherein, in a case where the correction unit corrects the correctable width for each light emitting element, the correction unit includes a first correctable width group making the correctable width larger than the reference value and a second correctable width group making the correctable width smaller than the reference value, and corrects the correctable width such that a total value of differences between the first correctable width group and the reference value and a total value of differences between the second correctable width group and the reference value are substantially equal to each other.

10. The light emitting device according to claim 1,
wherein the plurality of light emitting elements of the light source unit are divided and arranged in a plurality of sets, and
the correction unit makes the correctable width vary in parallel for each of the light emitting elements that are divided into the sets.

11. The light emitting device according to claim 10,
wherein the light source unit consists of a plurality of systems that use a common driving signal for each identical set, and
the correction unit performs processing of correcting the correctable width for the light emitting element belonging to any one set of systems and processing of correcting the correctable width for the light emitting element belonging to another set of systems in parallel.

12. An optical writing device comprising:
the light emitting device according to claim 1 that is provided to face an image holding unit on which an image formed using light is capable of being held; and
an imaging unit that forms an image on the image holding unit using light emitted from each light emitting element of the light emitting device,
wherein the image formed using the light is written on the image holding unit.

13. An optical writing device comprising:
the light emitting device according to claim 2 that is provided to face an image holding unit on which an image formed using light is capable of being held; and
an imaging unit that forms an image on the image holding unit using light emitted from each light emitting element of the light emitting device,
wherein the image formed using the light is written on the image holding unit.

14. An optical writing device comprising:
the light emitting device according to claim 3 that is provided to face an image holding unit on which an image formed using light is capable of being held; and
an imaging unit that forms an image on the image holding unit using light emitted from each light emitting element of the light emitting device,
wherein the image formed using the light is written on the image holding unit.

15. An optical writing device comprising:
the light emitting device according to claim 4 that is provided to face an image holding unit on which an image formed using light is capable of being held; and
an imaging unit that forms an image on the image holding unit using light emitted from each light emitting element of the light emitting device,
wherein the image formed using the light is written on the image holding unit.

16. An optical writing device comprising:
the light emitting device according to claim 5 that is provided to face an image holding unit on which an image formed using light is capable of being held; and
an imaging unit that forms an image on the image holding unit using light emitted from each light emitting element of the light emitting device,
wherein the image formed using the light is written on the image holding unit.

17. An optical writing device comprising:
the light emitting device according to claim 6 that is provided to face an image holding unit on which an image formed using light is capable of being held; and
an imaging unit that forms an image on the image holding unit using light emitted from each light emitting element of the light emitting device,
wherein the image formed using the light is written on the image holding unit.

18. An optical writing device comprising:
the light emitting device according to claim 7 that is provided to face an image holding unit on which an image formed using light is capable of being held; and
an imaging unit that forms an image on the image holding unit using light emitted from each light emitting element of the light emitting device,
wherein the image formed using the light is written on the image holding unit.

19. An optical writing device comprising:
the light emitting device according to claim 8 that is provided to face an image holding unit on which an image formed using light is capable of being held; and
an imaging unit that forms an image on the image holding unit using light emitted from each light emitting element of the light emitting device,
wherein the image formed using the light is written on the image holding unit.

20. An image forming system comprising:
an image holding unit on which an image formed using light is capable of being held; and
the optical writing device according to claim 12,
wherein the image formed using the light and held on the image holding unit is visualized and output.
